(19) United States
(12) Patent Application Publication
(10) Pub. No.: US 2023/0023974 A1
(43) Pub. Date: Jan. 26, 2023

(54) LIGHT SOCKET SURVEILLANCE SYSTEMS

(71) Applicant: SKYBELL TECHNOLOGIES IP, LLC, Irvine, CA (US)

(72) Inventor: Joseph Frank Scalisi, Yorba Linda, CA (US)

(21) Appl. No.: 17/950,982

(22) Filed: Sep. 22, 2022

Related U.S. Application Data
(63) Continuation of application No. 17/022,424, filed on Sep. 16, 2020.
Application No. 17/022,424 is a continuation of application No. 15/060,282, filed on Mar. 3, 2016, now abandoned.
Application No. 15/060,282 is a continuation-in-part of application No. 14/849,513, filed on Sep. 9, 2015, now Pat. No. 10,218,932.
Application No. 14/849,513 is a continuation-in-part of application No. 14/534,588, filed on Nov. 6, 2014, now Pat. No. 9,165,444.
Application No. 14/849,513 is a continuation of application No. 14/549,548, filed on Nov. 21, 2014, now Pat. No. 9,142,214.
Application No. 14/549,548 is a continuation of application No. 14/549,545, filed on Nov. 21, 2014, now Pat. No. 9,053,622.
Application No. 14/549,545 is a continuation-in-part of application No. 14/534,588, filed on Nov. 6, 2014, now Pat. No. 9,165,444.
(60) Provisional application No. 62/129,816, filed on Mar. 7, 2015.
(60) Provisional application No. 62/039,394, filed on Aug. 19, 2014.
(60) Provisional application No. 62/018,605, filed on Jun. 29, 2014.
(60) Provisional application No. 62/039,394, filed on Aug. 19, 2014.
(60) Provisional application No. 62/018,605, filed on Jun. 29, 2014.

(51) Int. Cl. H04N 7/14; H04N 7/15; H04N 7/18; H04N 5/232; G08B 13/196; H04N 5/225; G06F 3/16; H04M 1/02; H04M 11/02; F21V 33/00; F21K 9/23; H05B 45/00; H05B 47/12; H05B 47/19; H05B 47/125; H05B 47/13; G06V 20/52; G06V 40/16

(52) U.S. Cl. CPC H04N 7/142; H04N 7/15; H04N 7/183; H04N 5/23238; H04N 5/23206; G08B 13/19684; H04N 5/2252; G06F 3/167; H04N 5/23216; H04M 1/0291; G08B 13/19636; H04M 11/025; H04N 5/2251; F21V 33/0052; F21K 9/23; F21V 33/0056; H04N 5/2256; G08B 13/19695; H05B 45/00; H05B 47/12; H05B 47/19; H05B 47/125; H05B 47/13; G06V 20/52; G06V 40/172; H04N 5/33

(57) ABSTRACT

A light socket surveillance system can be used to enable a first party to communicate with a second party. The light socket surveillance system can be used to detect an audible notification from the first party. In response to detecting the audible notification from the first party, the light socket surveillance system can initiate a communication session with a remote computing device of the second party.

### CROSS-REFERENCE TO RELATED APPLICATIONS

The entire contents of the following application are incorporated by reference herein: U.S. Nonprovisional patent application Ser. No. 17/022,424; filed Sep. 16, 2020; and entitled LIGHT SOCKET SURVEILLANCE SYSTEMS.

The entire contents of the following application are incorporated by reference herein: U.S. Nonprovisional patent application Ser. No. 15/060,282; filed Mar. 3, 2016; and entitled LIGHT SOCKET SURVEILLANCE SYSTEMS.

The entire contents of the following application are incorporated by reference herein: U.S. Provisional Patent Application No. 62/129,816; filed Mar. 7, 2015; and entitled LIGHT SOCKET SURVEILLANCE SYSTEMS.

The entire contents of the following application are incorporated by reference herein: U.S. Nonprovisional patent application Ser. No. 14/549,548; filed Nov. 21, 2014; issued as U.S. Pat. No. 9,142,214 on Sep. 22, 2015; and entitled LIGHT SOCKET CAMERAS.

The entire contents of the following application are incorporated by reference herein: U.S. Nonprovisional patent application Ser. No. 14/549,545; filed Nov. 21, 2014; issued as U.S. Pat. No. 9,053,622 on Jun. 9, 2015; and entitled LIGHT SOCKET CAMERAS.

The entire contents of the following application are incorporated by reference herein: U.S. Nonprovisional patent application Ser. No. 14/534,588; filed Nov. 6, 2014; issued as U.S. Pat. No. 9,165,444 on Oct. 20, 2015; and entitled LIGHT SOCKET CAMERAS.

The entire contents of the following application are incorporated by reference herein: U.S. Nonprovisional patent application Ser. No. 14/849,513; filed Sep. 9, 2015; issued as U.S. Pat. No. 10,218,932 on Feb. 26, 2019; and entitled LIGHT SOCKET CAMERAS.

### BACKGROUND

### Technical Field

Various embodiments disclosed herein relate to devices and methods that enable people to observe remote locations. Certain embodiments relate to using a computing device to see video taken by a remotely located camera.

### Description of Related Art

Video cameras can record images of various events that are viewable by remotely located people. Additionally, video cameras can be supported by objects such as tripods. Furthermore, video cameras often require electrical power. Some video cameras receive electrical power from batteries and/or power outlets.

### SUMMARY

The disclosure describes methods for using a light socket surveillance system to enable a first party to communicate with a second party. The light socket surveillance system can include an outer housing defining a proximal end, a distal end that is opposite the proximal end, and a sidewall that extends between the proximal end and the distal end. In some embodiments, the light socket surveillance system includes a detection system having a camera, a speaker, and a microphone. The light socket surveillance system can include a screw thread contact located adjacent the proximal end of the outer housing. In some embodiments, the method includes detecting, via the microphone, an audible notification from the first party. In response to detecting the audible notification from the first party, the method can include initiating a communication session with a remote computing device of the second party.

The audible notification can comprise a voice command instructing the light socket surveillance system to contact the second party. Methods can include enabling, via the speaker and the microphone, the first party and the second party to audibly communicate with each other.

The audible notification can comprise a distress notification indicating that the first party requires assistance. The communication session can comprise an indication of the distress notification.

Methods can include recording a noise with the microphone; recording an image with the camera; and initiating a communication session with the remote computing device of the second party. The communication session can comprise an indication of at least one of the noise and image.

The sidewall can comprise a first portion and a second portion that is rotatable with respect to the first portion. The camera can be coupled to the second portion. Methods can further include determining whether the first party is located within a field of view of the camera. In response to detecting the audible notification and in response to determining that the first party is not located within the field of view of the camera, methods can include automatically rotating the second portion until the first party is located within the field of view of the camera. In response to determining that the first party is located within the field of view of the camera, methods can include recording the image with the camera.

In some embodiments, the method includes detecting an indication suggestive of a visitor's presence. In response to detecting the indication suggestive of the visitor's presence, methods can include determining a number of visitors present within a vicinity of the light socket surveillance system.

The light socket surveillance system can be located inside a home of a homeowner, and the vicinity can be a room located inside the home. The light socket surveillance system can be located outside a home of a homeowner, and the vicinity can be an area of an outer premise where the home is located.

In some embodiments, detecting an indication suggestive of a visitor's presence comprises detecting an infrared signature of the visitor. The light socket surveillance system can comprise an infrared camera. Accordingly, detecting the infrared signature of the visitor can comprise detecting the infrared signature of the visitor with the infrared camera.

In response to detecting the indication suggestive of the visitor's presence, the method can further include recording, by the camera, at least one of a video and image of the visitor; and initiating a communication session with a remote computing device. In some embodiments, the communication session comprises at least one of the video and image of the visitor.

Methods can include determining an identity of a first visitor. Methods can also include determining an identity of a second visitor. Methods can even include initiating a communication session with a remote computing device. The communication session can comprise the identity of the first visitor and the identity of the second visitor. The communication session can comprise the number visitors present within the vicinity of the light socket surveillance system. The remote computing device can be operated by a party associated with a building in which the light socket surveillance system is coupled.

The disclosure also a light socket surveillance system that can comprise an outer housing defining a proximal end, a distal end that is opposite the proximal end, and a sidewall that extends between the proximal end and the distal end. The light socket surveillance system can also include a screw thread contact coupled to the proximal end of the outer housing. The screw thread contact can be rotatably attached to a light socket. The light socket surveillance system can also include a detection system coupled to the outer housing. The detection system can comprise a camera configurable to record images, a speaker configurable to emit noise, and a microphone configurable to detect sound.

The outer housing can include a first outer housing and a second outer housing rotatable with respect to the first outer housing. The detection system can be coupled to the second outer housing such that the detection system is rotatable with respect to the first outer housing.

The light socket surveillance system can further include a motion detector coupled to the outer housing. The motion detector can be configured to detect an indication suggestive of a visitor's presence.

The light socket surveillance system can be configurable to determine an identity of a visitor based upon the second noise as detected by the microphone. The light socket surveillance system can even be configurable to detect a presence of a remote computing device. In such embodiments, the light socket surveillance system can be configured to determine an identity of a visitor associated with the remote computing device.

### BRIEF DESCRIPTION OF THE DRAWINGS

These and other features, aspects, and advantages are described below with reference to the drawings, which are intended to illustrate, but not to limit, the invention. In the drawings, like reference characters denote corresponding features consistently throughout similar embodiments.

FIG. 1a illustrates a front view of a communication system, according to some embodiments.

FIG. 1b illustrates a front view of a security system, according to some embodiments.

FIG. 2 illustrates a computing device running software, according to some embodiments.

FIG. 3 illustrates an embodiment in which a security system is connected to a building, according to some embodiments.

FIG. 4 illustrates a perspective view of a light socket, according to some embodiments.

FIG. 5 illustrates a perspective view of a light bulb mechanically and electrically coupled to a light socket, according to some embodiments.

FIG. 6 illustrates a perspective view of a security system prior to the security system being mechanically and electrically coupled to the light socket, according to some embodiments.

FIG. 7 illustrates the security system mechanically and electrically coupled to the light socket, according to some embodiments.

FIGS. 8 and 9 illustrate perspective views of security systems, according to some embodiments.

FIG. 10 illustrates a perspective view of electrical contacts, according to some embodiments.

FIG. 11 illustrates a side view of a security system with a cone-shaped mirror, according to some embodiments.

FIG. 12 illustrates a perspective view of the security system with a cone-shaped mirror, according to some embodiments.

FIGS. 13a, 13b, 13c, and 13d illustrate side views of security systems with respective dome camera assembly, according to various embodiments.

FIG. 13e illustrates a top-down view of a security system with a horizontal field of vision, according to some embodiments.

FIG. 14 illustrates a perspective view of a security system, according to some embodiments.

FIGS. 15 and 16 illustrate a user interface with an adjustable viewing orientation, according to some embodiments.

FIG. 17 illustrates a security system detecting a visitor, according to some embodiments.

FIGS. 18-27 illustrate flow-charts of various methods of using a security system, according to various embodiments.

FIG. 28a illustrates a security system detecting a sound, according to an embodiment.

FIGS. 28b-28f illustrate various responses to detecting the sound from FIG. 28a, according to various embodiments.

FIGS. 29 and 30 illustrate flow-charts of various methods of using a security system, according to various embodiments.

FIG. 31a illustrates a security system detecting an audible instruction, according to an embodiment.

FIGS. 31b-31f illustrate various responses to detecting the audible instruction from FIG. 31a, according to various embodiments.

FIGS. 32a and 32b illustrate various embodiments of a security system, first appliance and second appliance being located inside or outside a building, according to various embodiments.

FIGS. 33a and 33b illustrate various embodiments of a security system being connected to an appliance via a wireless connection and a wired connection, according to various embodiments.

FIG. 34 illustrates a flow-chart of a method of using a security system, according to an embodiment.

### DETAILED DESCRIPTION

Although certain embodiments and examples are disclosed below, inventive subject matter extends beyond the specifically disclosed embodiments to other alternative embodiments and/or uses, and to modifications and equivalents thereof. Thus, the scope of the claims appended hereto is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order dependent. Additionally, the structures, systems, and/or devices described herein may be embodied as integrated components or as separate components.

For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

### System Embodiments

Communication systems can provide a secure and convenient way for a remotely located individual to see and/or communicate with a person who is within the field of vision of a camera and/or within the range of a microphone. Communication systems can include a camera that is attached to a light socket to couple the camera to a wall and to provide electricity to the camera. It should be appreciated that communication systems can be referred to as security systems, light socket cameras, light socket surveillance systems, surveillance systems, and the like.

Some communication systems can allow an individual to hear, see, and talk with visitors. For example, communication systems can use a computing device to enable a remotely located person to see, hear, and/or talk with visitors. Computing devices can include computers, laptops, tablets, mobile devices, smartphones, cellular phones, and wireless devices (e.g., cars with wireless communication). Specifically, example computing devices include the iPhone, iPad, iMac, MacBook Air, and MacBook Pro made by Apple Inc. Communication between a remotely located person and a visitor can occur via the Internet, cellular networks, telecommunication networks, and wireless networks.

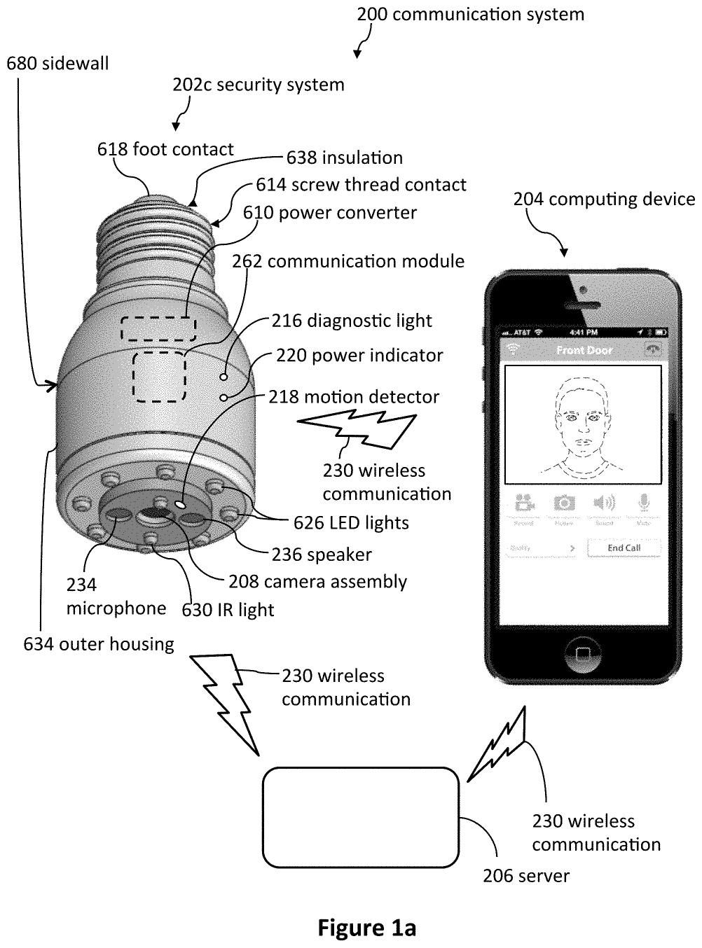

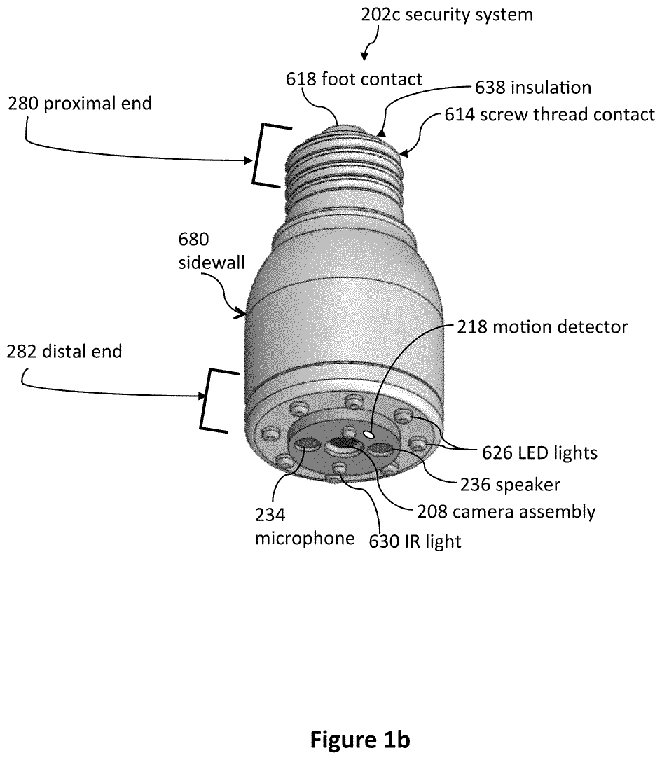

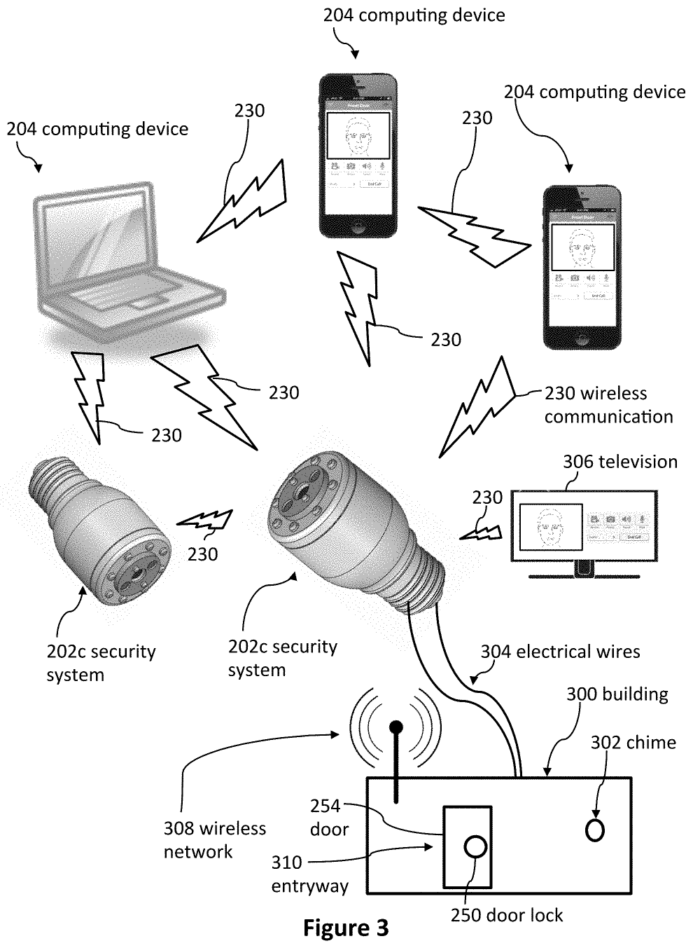

Referring now to FIG. 1a, communication systems 200 can be a portion of a smart home hub. Communication systems 200 can facilitate home automation. In some cases, cameras 208 are electrically coupled to a light socket of a building 300 and are integrated into a holistic home automation system and/or home security system. Various systems described herein enable home surveillance and/or complete home automation. Cameras 208 threadably screwed into an interior light socket can enable a remote user to see events inside of a building 300 (shown in FIG. 3). As well, cameras 208 threadably screwed into exterior light sockets can enable a remote user to see events outside of a building 300.

In some embodiments, the security system 202c controls various electrical items in a home (e.g., lights, air conditioners, heaters, motion sensors, garage door openers, locks, televisions, computers, entertainment systems, appliances, pool monitors, elderly monitors, and the like). In some embodiments, the computing device 204 controls the security system 202c and other electrical items in a home (e.g., lights, air conditioners, heaters, motion sensors, garage door openers, locks, televisions, computers, entertainment systems, appliance, pool monitors, elderly monitors, and the like).

FIG. 1 illustrates a front view of a communication system embodiment. The communication system 200 can include a security system 202c (e.g., a camera assembly) and a computing device 204. Although the illustrated security system 202c includes many components in one housing, several security system embodiments include components in separate housings. The security system 202c can include a camera assembly 208. The camera assembly 208 can include a video camera, which in some embodiments is a webcam. The camera assembly 208 can be configured to take videos of a surrounding area for viewing via the Internet. However, it should be appreciated that the camera assembly 208 can be a still camera, any type of digital camera, virtual camera, and the like. Generally, it should be appreciated that the camera assembly 208 can be any type of camera or optical instrument that records images that can be stored directly, transmitted to another location, or both.

Now with added reference to FIG. 1b, the security system 202c can include a proximal end 280 and a distal end 282 that is opposite the proximal end 280. The camera assembly 208 can be located at the distal end 282 of the security system 202c. However, it should be appreciated that the camera assembly 208 can be positioned at any location on the security system 202c, such as the sidewall 680. The security system 202c can also include a foot contact 618 located at the proximal end 280 of the security system 202c.

It should be appreciated that the security system 202c can include more than one camera assembly 208. For example, the security system 202c may include two cameras. In some embodiments, the security system 202c includes a first camera disposed at the distal end 282 of the security system 202c, and a second camera disposed along the sidewall 680 of the security system 202c. In this manner the second camera may face perpendicular to the direction the first camera is facing. This may allow the security system 202c to have a larger field of vision of the area to which the security system 202c is monitoring.

Moreover, the security system 202c can also include a third camera, a fourth camera, and a fifth camera. The cameras can be mounted at any location along the security system 202c to thereby expand the field of vision of the security system 202c. As well, the camera(s) 208 may be configured to move away from the security system 202c and pivot along at least two axes. The movement of the camera(s) 208 may be controlled via manual manipulation by a person, a command from a remote computing device 204, automatically in response to the occurrence of an event, or the like.

As shown in FIG. 1a, the security system 202c can include a diagnostic light 216 and a power indicator light 220. In some embodiments, the diagnostic light 216 is a first color (e.g., blue) if the security system 202c and/or the communication system 200 is connected to a wireless Internet network and is a second color (e.g., red) if the security system 202c and/or the communication system 200 is not connected to a wireless Internet network. In some embodiments, the power indicator 220 is a first color if the security system 202c is connected to a power source. The power source can be power supplied by the building 300 to which the security system 202c is attached. The security system 202c can receive electricity via the light socket to which the security system 202c is attached. In some embodiments, the power indicator 220 is a second color or does not emit light if the security system 202c is not connected to the power source.

The security system 202c (e.g., a camera assembly) can include an outer housing 634, which can be water resistant and/or waterproof. The outer housing 634 can be made from metal or plastic, such as molded plastic with a hardness of 60 Shore D. In some embodiments, the outer housing 634 is made from brushed nickel or aluminum. The outer housing 634 can be rigid.

Rubber seals can be used to make the outer housing 634 water resistant or waterproof The security system 202c can be electrically coupled to a power source, such as wires electrically connected to a building's electrical power system. In some embodiments, the security system 202c includes a battery for backup and/or primary power.

As shown in FIG. 1, the security system 202c can include a screw thread contact 614 having a proximal end adjacent the foot contact 618 and a distal end that is opposite the proximal end. The distal end of the screw thread contact 614 can be located adjacent the proximal end of the outer housing 634. The screw thread contact 614 can also include a threaded sidewall that extends between the proximal end and the distal end of the screw thread contact 614. In this manner, the threaded sidewall of the screw thread contact 614 can be configured to rotatably attach to the light socket 650.

The security system can include lights 626, which can be LED lights configured to illuminate a room and/or an outdoor area. In some embodiments, the lights 626 can provide at least 10 lumens, at least 1,000 lumens, at least 4,000 lumens, and/or less than 40,000 lumens. The lights 626 can be aligned such that the lights 626 are parallel to a central axis 266 of a screw thread contact 614. The lights 626 can be oriented such that they face away from the foot contact 618.

As well, the security system 202c can include lights 630, which can be infrared lights. The lights 630 can illuminate an area in front of the camera assembly's 208 field of vision to enable the camera assembly 208 to capture easily viewable and high-quality video. In this regard, the lights 630 can be located at the distal end 282 of the security system 202c, adjacent to the camera assembly 208. Infrared light can be suitable for nighttime video recording. In some embodiments the security system 202c includes a photosensor and/or a photodetector to determine whether the field of vision of the camera assembly 208 is illuminated. In response to determining that the field of vision is not illuminated, the security system 202c can illuminate the light and use the camera assembly 208 to record a video of the visitor. It should be appreciated that the security system 202c can include any type of sensor configured to determine an amount of light, such as a reverse-biased light emitting diode (LED), photovoltaic cell, photodiode, ultraviolet light sensor, and the like.

The lights 626 and 630 can be controlled by any number of means. For example, the security system 202c can be configured to receive a first instruction from the remote computing device 204. The first instruction can include a command to illuminate either or both of the lights 626 and/or 630. In response to receiving the first instruction from the remote computing device 204, the security system 202c can illuminate the lights 626 and/or 630. As well, the security system 202c can receive a second instruction from the remote computing device 204. The second instruction can include a command to de-activate the lights 626 and/or 630. Accordingly, in response to receiving the second instruction from the remote computing device 204, the security system 202c can de-activate the lights 626 and/or 630.

The security system 202c can also be configured to illuminate and de-activate the lights 626 and/or 630 in a number of different manners. For example, the security system 202c can be configured to receive an audible instruction via the microphone 234 of the security system 202c. The audible instruction can be a spoken command by the visitor to thereby illuminate and/or de-activate the lights 626 and/or 630. For example, the audible instruction can be the visitor saying, “Turn lights on,” “Illuminate lights,” “Lights off,” “Dim lights,” and the like. Generally, the audible instruction can be any spoken command or noise from the visitor, which is thereby received by the security system 202c to illuminate the lights. Accordingly, in response to receiving the audible instruction from the visitor, the security system 202c can illuminate or de-activate the lights 626 and/or 630.

As well, the security system 202c can include a communication module 262 configured to enable wireless communication with the computing device 204. The communication module 262 can include a WiFi antenna and can be configured to enable the security system 202c to connect to a wireless network 308 of a building 300 (shown in FIG. 3).

Wireless communication 230 can enable the security system 202c (e.g., a camera assembly) to communicate with the computing device 204. Accordingly, the security system 202c may include a communication module 262 located within an internal portion of the outer housing 634. The communication module 262 may be configured to connect to a wireless communication network. Some embodiments enable communication via cellular and/or WiFi networks. Some embodiments enable communication via the Internet. Several embodiments enable wired communication between the security system 202c and the computing device 204. The wireless communication 230 can include the following communication means: radio, WiFi (e.g., wireless local area network), cellular, Internet, Bluetooth, telecommunication, electromagnetic, infrared, light, sonic, and microwave. Other communication means are used by some embodiments. In some embodiments, such as embodiments that include telecommunication or cellular communication means, the security system 202c can initiate voice calls or transmit text messages to a computing device 204 (e.g., a smartphone, a desktop computer, a tablet computer, a laptop computer).

Several embodiments use near field communication (NFC) to communicate between the computing device 204 and the security system 202c. The security system 202c and/or the computing device 204 can include a NFC tag. Some NFC technologies include Bluetooth, radio-frequency identification, and QR codes.

Several embodiments include wireless charging (e.g., near field charging, inductive charging) to supply power to and/or from the security system 202c and the computing device 204. Some embodiments use inductive charging (e.g., using an electromagnetic field to transfer energy between two objects).

Some embodiments include computer software (e.g., application software), which can be a mobile application designed to run on smartphones, tablet computers, and other mobile devices. Software of this nature is sometimes referred to as “app” software. In some embodiments the computer software includes software designed to run on desktop computers and laptop computers.

The computing device 204 can run software with a graphical user interface. The user interface can include icons or buttons. In some embodiments, the software is configured for use with a touch-screen computing device such as a smartphone or tablet.

The security system 202c can include a motion detector 218 configured to detect the presence of people (e.g., in the outdoor area or room in which the security system 202c is located) or objects. The security system 202c can also be placed outdoors to detect people or objects outside. The motion detector 218 can be an infrared motion detector.

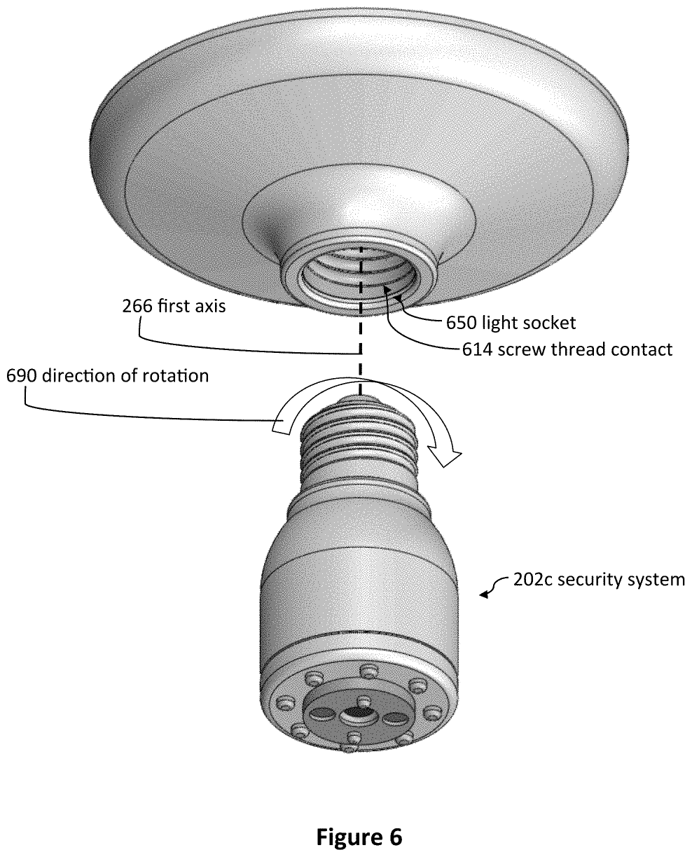

As illustrated in FIGS. 6-10, the security system 202c can be attached to a light socket 650 to couple the security system 202c to an electrical power source (e.g., of a building 300 shown in FIG. 3). The security system 202c can include a screw thread electrical contact 614, which can comprise a conductive metal. The security system 202c can also include a foot electrical contact 618, which can comprise a conductive metal. The screw thread contact 614 can be electrically insulated from the foot electrical contact 618 by insulation 638.

The security system 202c can be coupled to the light socket 650 via any number of connection methods. For example, the screw thread contact 614 of the security system 202c can be rotatably attached to the light socket 650 to thereby couple the security system 202c to the light socket 650. When the security system 202c is coupled to the light socket 650, the foot contact 618 of the security system 202c can be electrically coupled to the foot contact 654 of the light socket 650, to thereby couple the security system 202c to the electrical power source (i.e. to energize the security system 202c).

It should also be appreciated that the security system 202 may be implemented with a theft prevention system (not shown). The theft prevention system may be a lock that only authorized users may be able to unlock to thereby remove the security system 202 from the light socket 650. The lock may be mechanical or electrical, thus allowing the security system 202 to prevent theft.

A power converter 610 can be electrically coupled to the screw thread contact 614 and the foot contact 618. The power converter 610 can be configured to convert electricity from the building 300 (shown in FIG. 3) to a type of power that is more suitable for the security system 202c. In some embodiments, the power converter 610 converts an input voltage to a lower voltage and/or converts AC to DC power. Furthermore, it should be appreciated that the power converter 610 can be configured to adapt to the input voltages of any country, and thereby convert the input voltage to a voltage suited for the security system 202c.

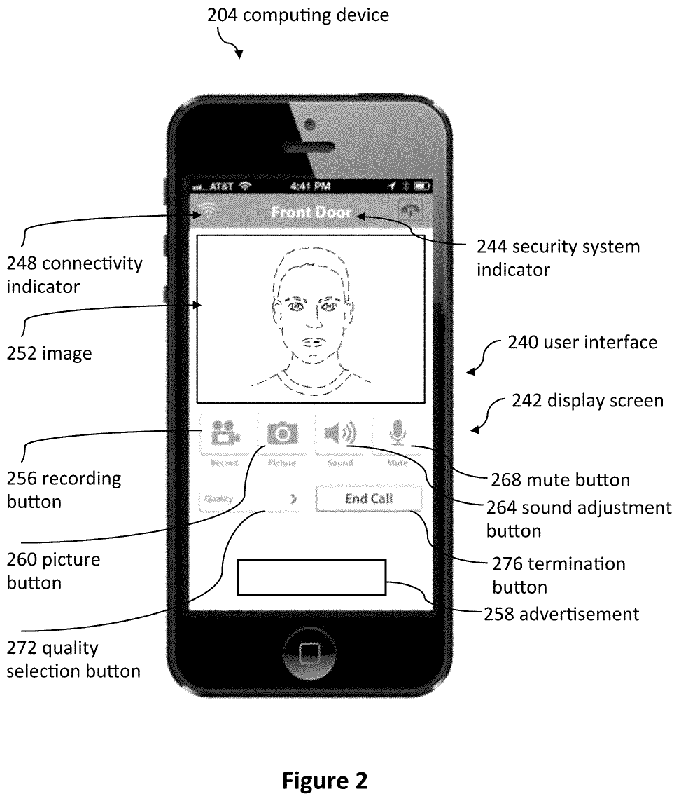

FIG. 2 illustrates a computing device 204 running software. The software includes a user interface 240 displayed on a display screen 242. The user interface 240 can include a security system indicator 244, which can indicate the location of the security system that the user interface is displaying. For example, a person can use one computing device 204 to control and/or interact with multiple security systems, such as one security system located at a front door and another security system located at a back door. Selecting the security system indicator 244 can allow the user to choose another security system (e.g., the back door security system rather than the front door security system).

The user interface 240 can include a connectivity indicator 248. In some embodiments, the connectivity indicator can indicate whether the computing device is in communication with a security system, the Internet, and/or a cellular network. The connectivity indicator 248 can alert the user if the computing device 204 has lost its connection with the security system 202c; the security system 202c has been damaged; the security system 202c has been stolen; the security system 202c has been removed from its mounting location; the security system 202c has lost electrical power; and/or if the computing device 204 cannot communicate with the security system 202c. In some embodiments, the connectivity indicator 248 alerts the user of the computing device 204 by flashing, emitting a sound, displaying a message, and/or displaying a symbol.

Referring now to FIG. 1a, in some embodiments, if the security system 202c loses power, loses connectivity to the computing device 204, loses connectivity to the Internet, and/or loses connectivity to a remote server, a remote server 206 transmits an alert (e.g., phone call, text message, image on the user interface 240) regarding the power and/or connectivity issue. In several embodiments, the remote server 206 can manage communication between the security system 202c and the computing device 204. In some embodiments, information from the security system 202c is stored by the remote server 206. In several embodiments, information from the security system 202c is stored by the remote server 206 until the information can be sent to the computing device 204, uploaded to the computing device 204, and/or displayed to the remotely located person via the computing device 204. The remote server 206 can be a computing device that stores information from the security system 202c and/or from the computing device 204. In some embodiments, the remote server 206 is located in a data center.

In some embodiments, the computing device 204 and/or the remote server 206 attempt to communicate with the security system 202c. If the computing device 204 and/or the remote server 206 is unable to communicate with the security system 202c, the computing device 204 and/or the remote server 206 alerts the remotely located person via the software, phone, text, a displayed message, and/or a website.

In some embodiments, the computing device 204 and/or the remote server 206 attempts to communicate with the security system 202c periodically; at least every five hours and/or less frequently than every 10 minutes; at least every 24 hours and/or less frequently than every 60 minutes; or at least every hour and/or less frequently than every second.

In some embodiments, the server 206 can initiate communication to the computer device 204 and/or to the security system 202c. In several embodiments, the server 206 can initiate, control, and/or block communication between the computing device 204 and the security system 202c.

In several embodiments, a user can log in to an “app,” website, and/or software on a computing device (e.g., mobile computing device, smartphone, tablet, desktop computer) to adjust the security system settings discussed herein.

In some embodiments, a computing device can enable a user to watch live video and/or hear live audio from a security system due to the user's request rather than due to actions of a visitor. Some embodiments include a computing device initiating a live video feed (or a video feed that is less than five minutes old).

Referring now to FIG. 2, in some embodiments, the user interface 240 displays an image 252 such as a still image or a video of an area near and/or in front of the security system 202c. The image 252 can be taken by the camera assembly 208 and stored by the security system 202c, server 206, and/or computing device 204. The user interface 240 can include a recording button 256 to enable a user to record images, videos, and/or sound from the camera assembly 208, microphone of the security system 202c, and/or microphone of the computing device 204.

In several embodiments, the user interface 240 includes a picture button 260 to allow the user to take still pictures and/or videos of the area near and/or in front of the security system 202c. The user interface 240 can also include a sound adjustment button 264 and a mute button 268. The user interface 240 can include camera manipulation buttons such as zoom, pan, and light adjustment buttons. In some embodiments, the camera assembly 208 automatically adjusts between Day Mode and Night Mode. Some embodiments include an infrared camera and/or infrared lights to illuminate an area near the security system 202c to enable the camera assembly 208 to provide sufficient visibility (even at night).

In some embodiments, buttons include diverse means of selecting various options, features, and functions. Buttons can be selected by mouse clicks, keyboard commands, or touching a touch screen. Many embodiments include buttons that can be selected without touch screens.

In some embodiments, the user interface 240 includes a quality selection button, which can allow a user to select the quality and/or amount of data transmitted from the security system 202c to the computing device 204 and/or from the computing device 204 to the security system 202c.

In some embodiments, video can be sent to and/or received from the computing device 204 using video chat protocols such as FaceTime (by Apple Inc.) or Skype (by Microsoft Corporation). In some embodiments, these videos are played by videoconferencing apps on the computing device 204 instead of being played by the user interface 240.

As shown in FIG. 2, the user interface 240 can include a termination button 276 to end communication between the security system 202c and the computing device 204. In some embodiments, the termination button 276 ends the ability of the person located near the security system 202c (i.e., the visitor) to hear and/or see the user of the computing device 204, but does not end the ability of the user of the computing device 204 to hear and/or see the person located near the security system 202c.

In some embodiments, a button 276 is both an answer button (to accept a communication request from a visitor) and a termination button (to end communication between the security system 202c and the computing device 204). The button 276 can include the word “Answer” when the system is attempting to establish two-way communication between the visitor and the user. Selecting the button 276 when the system is attempting to establish two-way communication between the visitor and the user can start two-way communication. The button 276 can include the words “End Call” during two-way communication between the visitor and the user. Selecting the button 276 during two-way communication between the visitor and the user can terminate two-way communication. In some embodiments, terminating two-way communication still enables the user to see and hear the visitor. In some embodiments, terminating two-way communication causes the computing device 204 to stop showing video from the security system and to stop emitting sounds recorded by the security system.

In some embodiments, the user interface 240 opens as soon as the security system 202c detects a visitor (e.g., senses indications of a visitor). Once the user interface 240 opens, the user can see and/or hear the visitor. The security system 202c can include a microphone 234 and a speaker 236 to enable the user to hear the visitor and to enable the visitor to hear the user. In this regard, the speaker 236 may be configured to transmit an audible message to the visitor and the microphone 234 may be configured to receive an audible message from the visitor. In some embodiments the speaker 236 and microphone 234 are located within an internal portion of the outer housing 634. However, in other embodiments, the speaker 236 and microphone 234 are located along an external surface of the outer housing 634. Thus, the security system 202c can enable the user to communicate with the visitor.

Some method embodiments include detecting a visitor with a security system. The methods can include causing the user interface 240 (shown in FIG. 2) to display on a remote computing device 204 due to the detection of the visitor (e.g., with or without user interaction). The methods can include displaying video from the security system and/or audio from the security system.

In some embodiments, the software includes means to start the video feed on demand. For example, a user of the computing device might wonder what is happening near the security system 202c. The user can open the software application on the computing device 204 and instruct the application to show live video and/or audio from the security device 202c even if no event near the security system 202c has triggered the communication.

In several embodiments, the security device 202c can be configured to record video, images, and/or audio when the security device 202c detects movement and/or the presence of a person. The user of the computing device 204 can later review all video, image, and/or audio records when the security device 202c detected movement and/or the presence of a person.

Referring now to FIG. 1a, in some embodiments, the server 206 controls communication between the computing device 204 and the security system 202c, which can include a camera, a microphone, and a speaker. In several embodiments, the server 206 does not control communication between the computing device 204 and the security system 202c.

In some embodiments, data captured by the security system and/or the computing device 204 (such as videos, pictures, and audio) is stored by another remote device such as the server 206. Cloud storage, enterprise storage, and/or networked enterprise storage can be used to store video, pictures, and/or audio from the communication system 200 or from any part of the communication system 200. The user can download and/or stream stored data and/or storage video, pictures, and/or audio. For example, a user can record visitors for a year and then later can review the visits from the last year. In some embodiments, remote storage, the server 206, the computing device 204, and/or the security system 202c can store information and statistics regarding visitors and usage.

The communication system 200 can include the security system 202c, the computing device 204, and/or the server 206. Some communication systems use many systems to enable communication between the security system 202c and the computing device 204.

FIG. 3 illustrates an embodiment in which a security system 202c is connected to a building 300, which can include an entryway 310 that has a door 254. Electrical wires 304 can electrically couple the security system 202c to the electrical system of the building 300 such that the security system 202c can receive electrical power from the building 300 (e.g., via a light socket that is attached to the building 300).

A wireless network 308 can allow devices to wirelessly access the Internet. The security system 202c can access the Internet via the wireless network 308. The wireless network 308 can transmit data from the security system 202c to the Internet, which can transmit the data to remotely located computing devices 204. The Internet and wireless networks can transmit data from remotely located computing devices 204 to the security system 202c. In some embodiments, a security system 202c connects to a home's WiFi.

As illustrated in FIG. 3, one computing device 204 (e.g., a laptop, a smartphone, a mobile computing device, a television) can communicate with multiple security systems 202c. In some embodiments, multiple computing devices 204 can communicate with one security system 202c.

In some embodiments, the security system 202c can communicate (e.g., wirelessly 230) with a television 306, which can be a smart television. Users can view the television 306 to see a visitor and/or talk with the visitor.

As well, in some embodiments, the visitor and user of the remote computing device 204 are able to talk with each other, via the security system 202c and the remote computing device 204. For example, the security system 202c may be configured to transmit a first audible message to the visitor. The first audible message may be received by a microphone in the remote computing device 204 and transmitted to the security system 202c. In this regard, the first audible message may be audibly transmitted to the visitor via the speaker 236 in the security system 202c. As well, the security system may be configured to transmit a second audible message to a user of the remote computing device 202c. The second audible message may be received by the microphone 234 in the security system 202c and transmitted to the remote computing device. In this regard, the second audible message may audibly transmitted to the user via a speaker in the remote computing device 204.

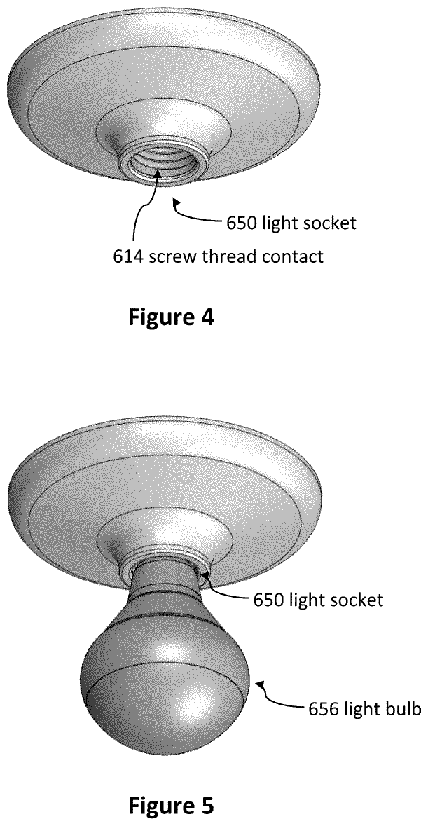

FIG. 4 illustrates a perspective view of a light socket 650. The light socket 650 can include a screw thread contact 652 configured to mechanically and electrically couple with the screw thread contact 614 of the security system 202c (shown in FIG. 1a). The light socket 650 can also include a foot contact 654 configured to electrically couple with the foot contact 618 of the security system 202c (shown in FIG. 1a). The foot contact 654 of the light socket 650 can be located at the distal end of the light socket 650.

In some embodiments, the security system 202c can be described as having a proximal end and a distal end that is opposite the proximal end. The camera assembly 208 can be located at the distal end of the security system 202c. The security system 202c can include the foot electrical contact 618 located at the proximal end of the security system 202c. In order to energize the security system 202c, the security system 202c can be oriented such that the foot electrical contact 618 faces the foot contact 654 of the light socket 650. In this manner the distal end of the security system 202c faces away from the foot contact 654 of the light socket 650. As well, the camera assembly 608 can face away from the foot contact 654 of the light socket 650. Once the security system 202c is oriented in this manner, the security system 202c can be attached to the light socket 650.

In some embodiments, the security system 202c is rotated as it is attached to the light socket 650. As shown in FIG. 6, the security system 202c can be rotated in a direction of rotation 690 about a first axis 266 to thereby attach the security system 202c to the light socket 650. As such, the foot contact 654 of the light socket 650 can be electrically coupled to the security system 202c. Furthermore, in many embodiments the foot contact 654 of the light socket 650 is electrically coupled to a light switch (not shown). In this manner, the foot contact 654 of the light socket 650, and the foot contact 618 of the security system 202c can be energized, when the light switch is activated (i.e. turned on).

FIG. 5 illustrates a perspective view of a light bulb 656 mechanically and electrically coupled to the light socket 650. The light bulb 656 can be removed and replaced by a security system that comprises lights and a camera.

FIG. 6 illustrates a perspective view of the security system 202c just before the security system 202c is screwed into the light socket 650 to mechanically couple the security system 202c to a wall and/or to a building 300. Screwing the security system 202c into the light socket 650 also enables the security system 202c to receive electricity from the building 300 (shown in FIG. 3).

In embodiments, the light socket 650 may be compatible with any number of standards for socket sizes. For example, the light socket 650 may use the Edison screw E26 or E27 standard or a bayonet mount. Various voltages may be carried to provide electrical power to the security system (e.g., 100V to 240V) depending on the local electrical standards.

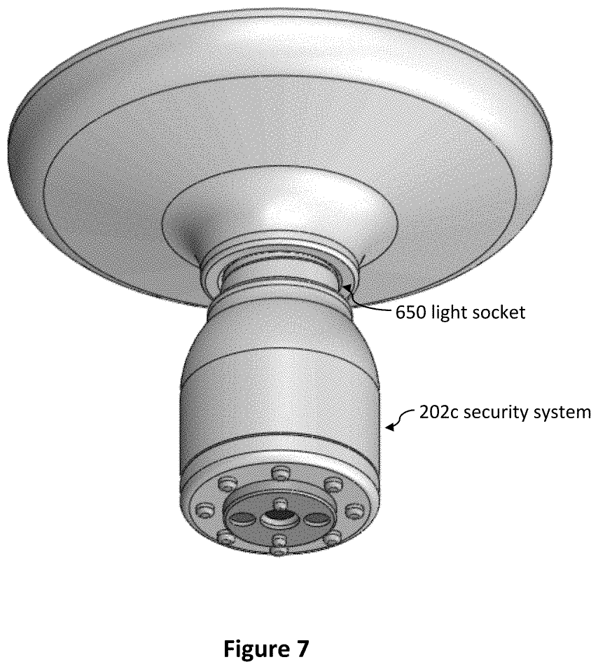

FIG. 7a illustrates the security system 202c screwed into the light socket 650. In this configuration, the security system 202c is electrically coupled to a power supply of the building 300. The light socket 650 can be located indoors or outdoors.

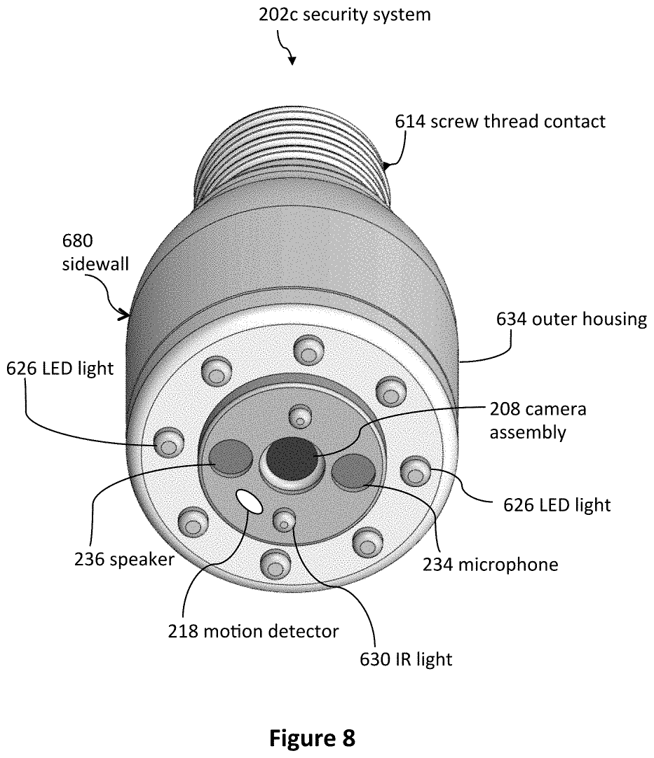

FIG. 8 illustrates a perspective view of the security system 202c. Not all of the lights 626, 630 are labeled to clarify other features. The camera assembly 208 can be aligned with a central axis 266 of the screw thread contact 614. The camera assembly 208 can include a fisheye lens. The camera assembly 208 can also include a cone-shaped mirror to enable viewing 360 degrees around the camera and/or around the outer housing 634. Software can be used to convert videos and/or pictures taken using the cone-shaped mirror into different formats (e.g., that are easier for users to interpret and/or include less distortion).

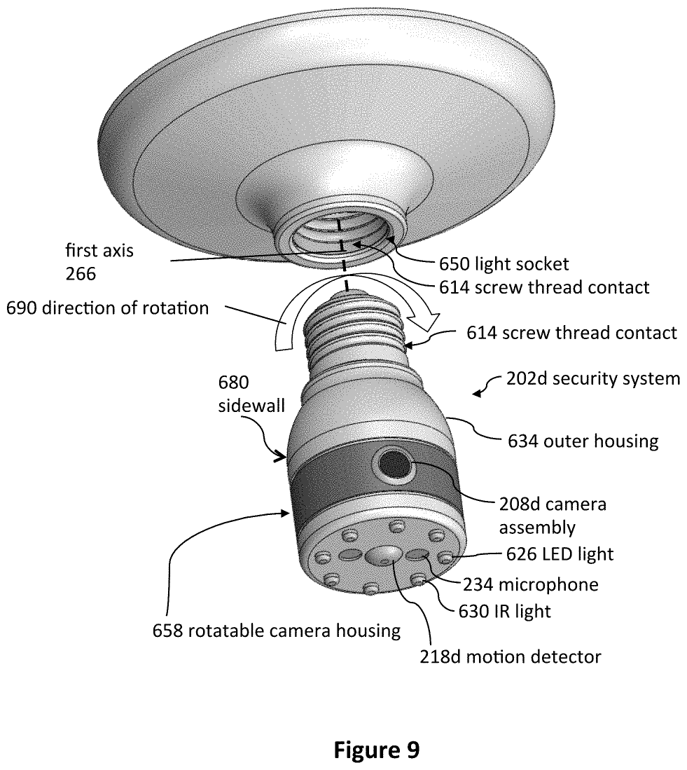

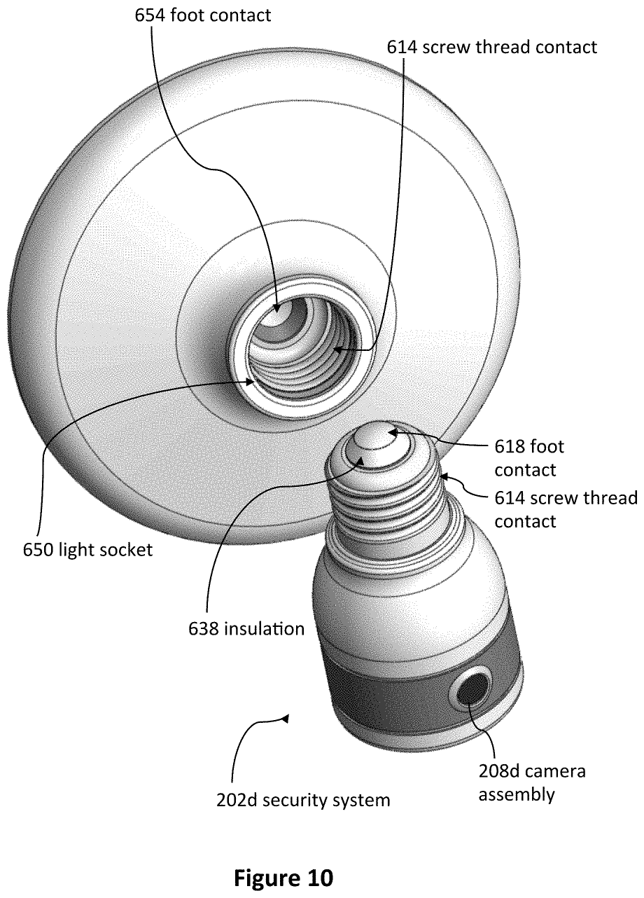

FIGS. 9 and 10 illustrate a security system 202d that can include any of the features described in the context of the security system 202c shown in FIGS. 1a, 1b and 3-8. The security system 202d, as shown in FIG. 9, can also be configured to screw into the light socket 650. In this manner, the security system 202d can be rotated in a direction of rotation 690 about a first axis 266 to thereby attach the security system 202d to the light socket 650. The security system 202d can include a camera assembly 208d that faces a radial direction that is perpendicular to the first axis 266.

As shown in FIG. 9, the security system 202d can include a motion detector 218d configured to detect visitors (e.g., people moving outside of a building 300, people moving inside of a room). The motion detector 218d can be located at the distal end of the security system 202c such that the motion detector 218d faces away from the foot contact 618 of the security system 202c.

Furthermore, the security system 202d can include a rotatable camera housing 658. A camera assembly 208d can be coupled to the rotatable camera housing 658 such that the camera assembly 208d rotates around the perimeter of the outer housing 634 of the security system 202d as the camera housing 658 rotates around the perimeter of the outer housing 634. The camera housing 658 can rotate around a central axis 266 of the screw thread contact 614.

In some embodiments, the camera housing 658 can rotate in response to an event, such as a person entering a room, outdoor area, or space adjacent to the security system 202c. For example, the motion detector 218d can detect the person(s), such as the visitor(s), and in response to the motion detector 218d detecting the person(s), the security system 202c can cause the camera housing 658 to rotate to a position whereby the camera assembly 208 can record an image and/or video of the person(s).

The camera housing 658 can be rotated via any number of rotation methods. In some embodiments, the rotation of the camera housing 658 is caused by a command from a remote computing device, such as a smart phone, tablet, or other cellular device. For example, a user of the remote computing device can input a command into an app that is run on the remote computing device. The command can then be transmitted from the remote computing device to the security system 202c, to thereby rotate the camera housing 658.

Describing the camera housing 658 differently, the sidewall 680 of the security system 202c can comprise a first portion, such as an outer housing 634, and a second portion, such as a rotatable camera housing 658, which is distal to the first portion. The second portion, or rotatable camera housing 658, can be rotatable about the first axis 266. The camera housing 658 can be manually rotated by the user. For example, the user can grip the camera housing 658 with his or her hand and rotate the camera housing 658 to a desired position. As well, the camera housing 658 can be rotated by the security system 202c, such as, in response to an event. For example, when the security system 202c detects the visitor, via the motion detector 218d, the security system 202c can then determine whether the visitor is located within a field of vision of the camera 208. Accordingly, in response to determining that the visitor is not located within the field of vision of the camera 208, the security system 202c can rotate the second portion, or camera housing 658. Furthermore, the security system 202c can rotate the camera 208 about the first axis until 266 the visitor is within a field of vision of the camera 208.

Additionally, the security system 202c may be configured to receive an instruction from a remote computing device 204. The instruction may include a command to rotate the second portion, or camera housing 658, to any location as determined by the user of the remote computing device 204. Accordingly, in response to receiving the instruction from the remote computing device 204, the security system 202c may be configured to rotate the second portion such that the camera 208 rotates about the first axis 266. As such, the user of the remote computing device 204 may be able to remotely rotate the camera housing 658 to thereby change the field of vision of the camera 208.

The security system 202d can use a microphone 234 to listen for visitors. When the security system 202d detects visitors (e.g., via motion or sound), the security system 202d can turn on LED lights 626, record sounds from the visitors, and/or take videos of the visitors. In some embodiments, the security system 202d records when visitors move by the security system 202d.

FIG. 10 illustrates a perspective view of electrical contacts. Connecting the security system 202d to the light socket 650 can enable the security system 202d to be electrically connected to a power supply.

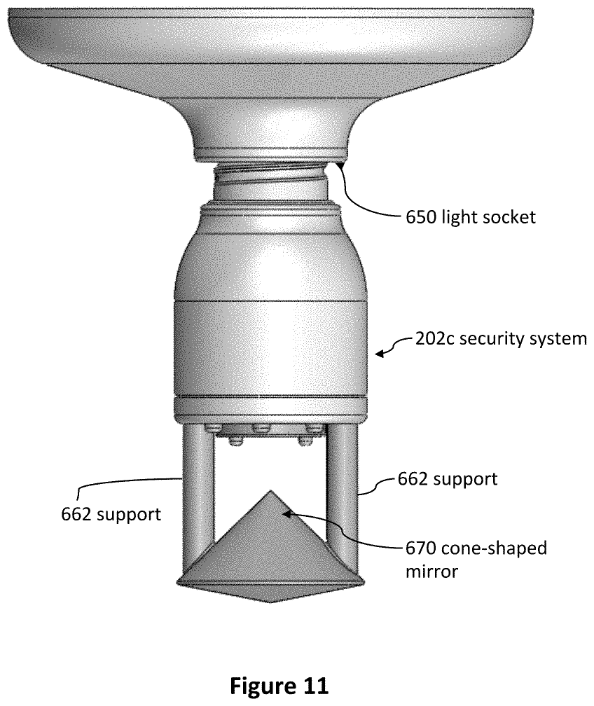

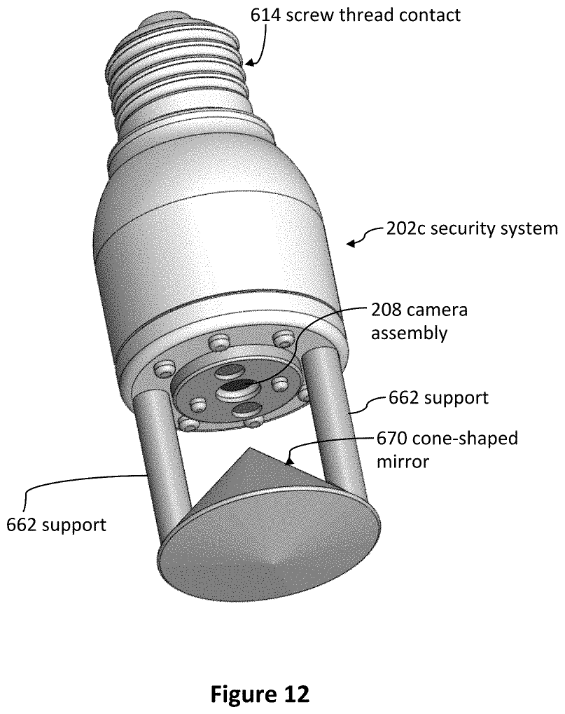

FIG. 11 illustrates a side view of a security system 202c with a cone-shaped mirror 670. Supports 662 can extend from an end of the security system 202c that is opposite an end that includes the screw thread contacts 614 (labeled in FIG. 12).

FIG. 12 illustrates a perspective view of the security system with a cone-shaped mirror 670. The camera assembly 208 can include a camera that is oriented towards the cone-shaped mirror to enable the security system 202c to record visitors in many directions around the security system 202c. Software can be used by the security system 202c, the remote computing device 204, and/or the server 206 to reduce and/or eliminate distortion in pictures taken using the security system 202c.

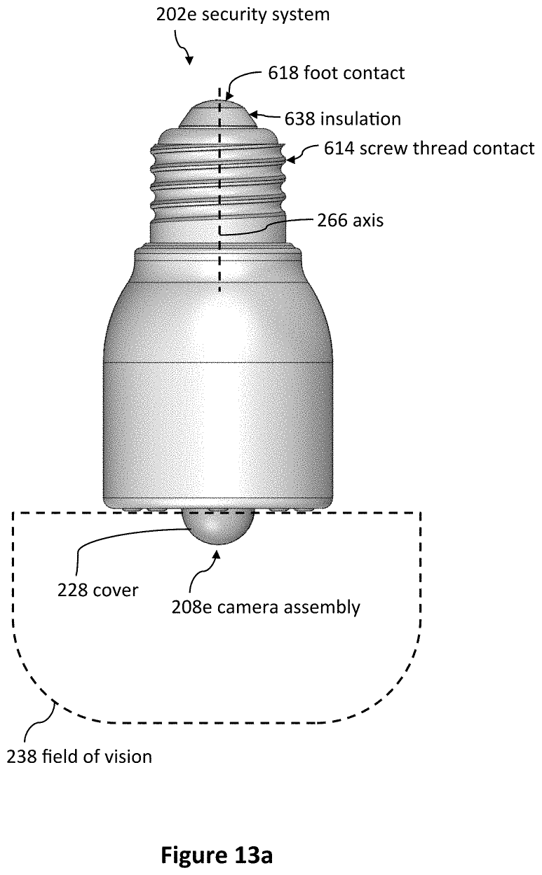

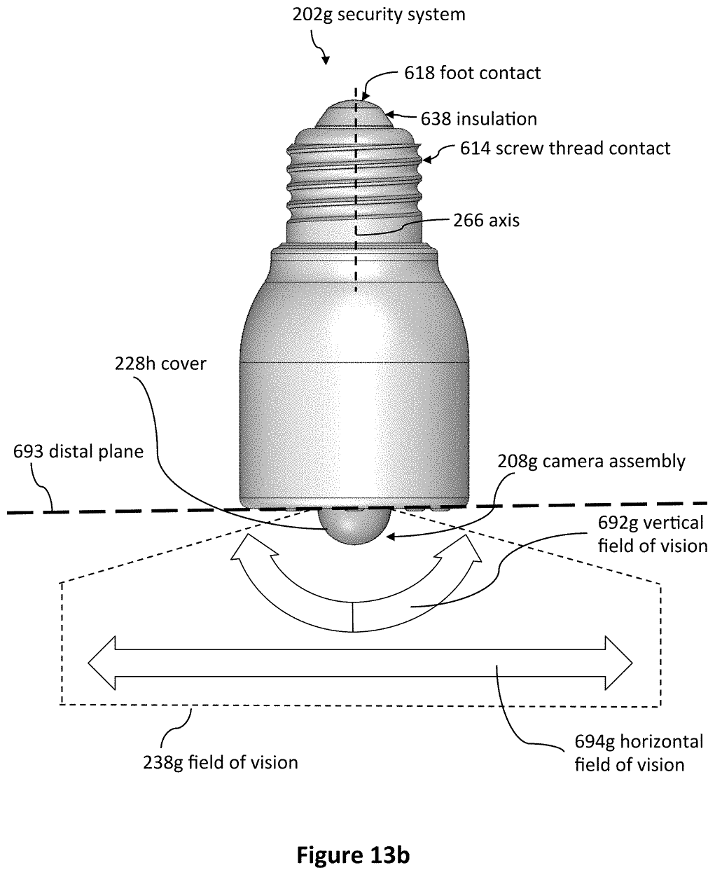

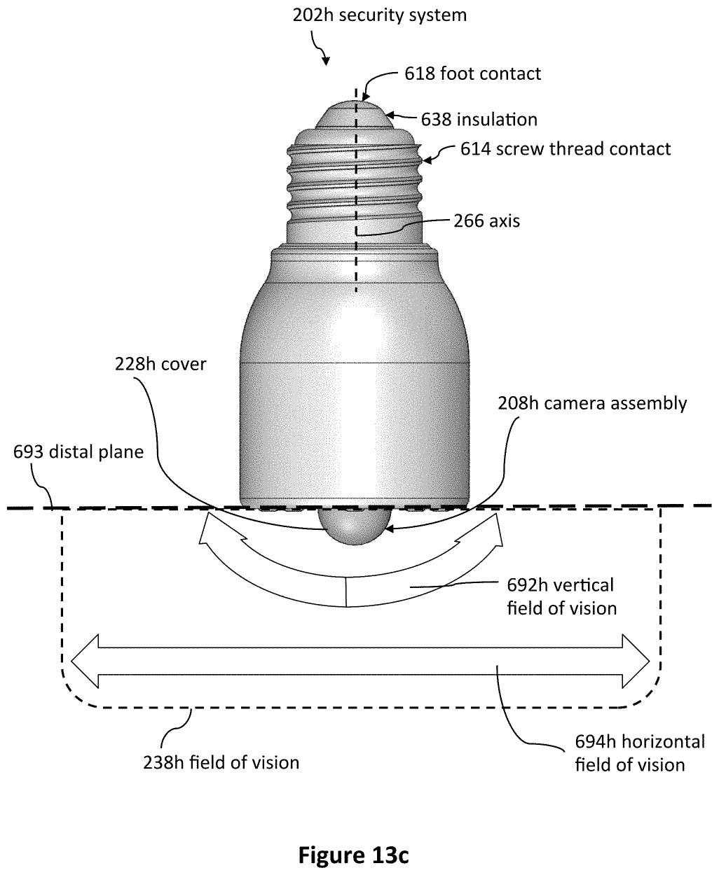

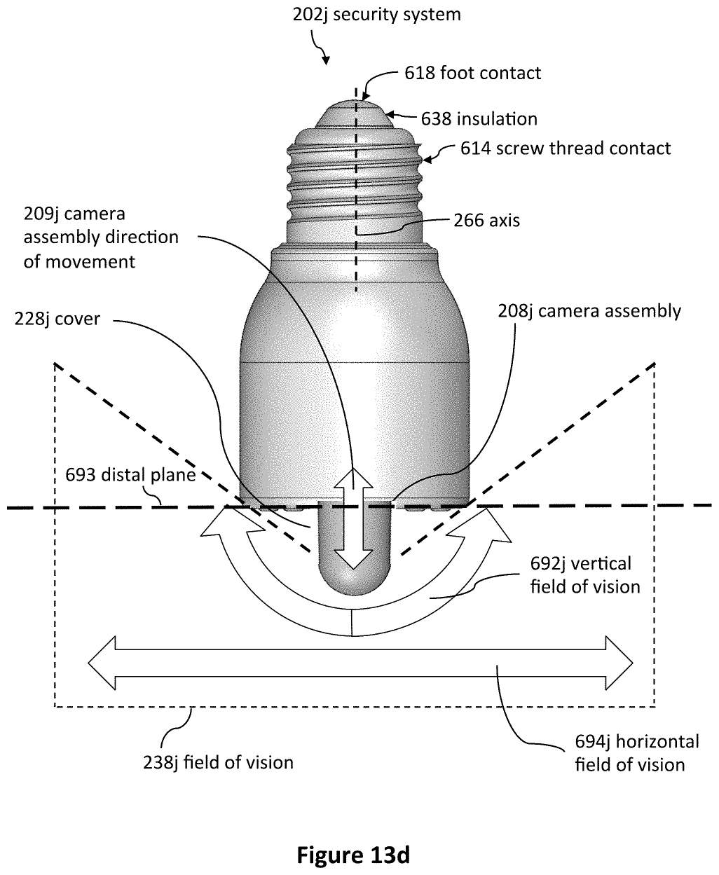

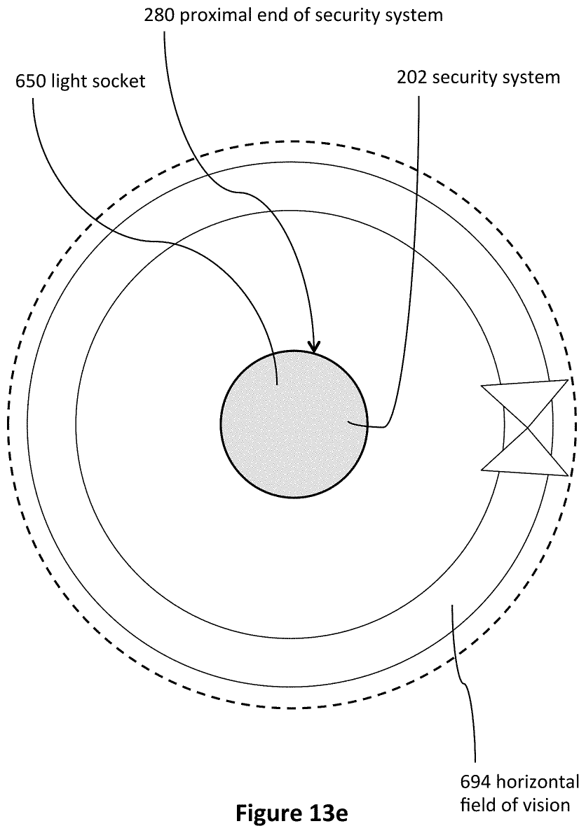

FIG. 13a illustrates a side view of a security system 202e with a dome camera assembly 208e. The dome camera assembly 208e can have a shape that is half of a sphere. In some embodiments, the dome camera assembly 208e includes an outer cover 228 that has a curved and/or spherical shape (e.g., half of a sphere). The cover 228 can be a translucent material such as plastic and/or polycarbonate.

The field of vision 238 of the dome camera assembly 208e can include half of a sphere. In some embodiments, the field of vision 238 includes approximately 360 degrees around the base of the cover 228 and/or around a central axis 266 of the screw thread contacts 614. In several embodiments, the field of vision 238 includes at least 330 degrees around the base of the cover 228. In some embodiments, the field of vision 238 is approximately 180 degrees in a plane that includes the central axis 266 of the screw thread contacts 614 (e.g., in the plane represented by the page on which FIG. 13a appears). In several embodiments, the field of vision 238 is at least 140 degrees and/or less than 260 degrees in a plane that includes the central axis 266.

FIGS. 13b-13e further illustrate the field of vision in various embodiments. With specific reference to FIG. 13b, the field of vision 238g can be defined by a vertical field of vision 692g and a horizontal field of vision 694g. The vertical field of vision 692g can be any angle less than 180 degrees (as shown by the distal plane 693), such as 140 degrees. Because FIGS. 13b-13e are side views, the horizontal field of vision 692g and the vertical field of vision 694g are actually radial, meaning that they extend 360 degrees around the perimeter of the camera assembly 208g. This 360 degree periphery is further illustrated in FIG. 13e. FIG. 13e is a top down view, looking from above the security system (when it is mounted to the light socket 650) to the ground below the security system. FIG. 13e shows that the horizontal field of vision 694, 694g actually covers 360 degrees around the perimeter of the security system and the axis 266. While the vertical field of vision is not illustrated in FIG. 13e, the vertical field of vision is also radial, in that it covers the 360 degree area around the security system.

The security system 202h illustrated in FIG. 13c may define a 180 degree vertical field of vision, which means that the camera assembly 208h is able to see anything that is level with or below the distal plane 693.

Furthermore, as shown in FIG. 13d, the security system 202j may be configured to achieve a vertical field of vision 692j that is greater than 180 degrees. For example, some embodiments may have a vertical field of vision equal to at least 250 degrees, up to 250 degrees, up to 280 degrees, and in some embodiments, up to 300 degrees. (It should be appreciated that in some embodiments that utilize multiple cameras, a vertical field of vision of up to 360 degrees may be achieved.) In the embodiment shown in FIG. 13d, to accomplish a vertical field of vision greater than 180 degrees, the camera assembly 208j may be configured to move vertically downward. Specifically, the camera assembly 208j may be configured to move along a camera assembly direction of movement 209j, as shown in FIG. 13d. In this regard, the camera assembly 208j may thereby gain separation from the distal end of the security system 202j. This may allow the camera assembly 208j to achieve a greater line of sight past the sidewalls in the upward, or proximal, direction.

It should be appreciated that various methods may be used to retain the camera assembly 208h at various locations along the camera assembly direction of movement 209h. In some embodiments, the camera assembly 208h may be configured to engage mechanical latches to secure the camera assembly 208h at discrete locations along the direction of movement 209h. In some embodiments, the camera assembly 208h may be configured to be retained at any location along the direction of movement 209h via friction. In some embodiments, the camera assembly 208h may be threadably engaged and disengaged at various locations along the direction of movement 209h. As well, once the camera assembly 208h has been moved to its desired vertical position, the camera assembly 208h is still thereby mechanically and electrically coupled to the security system.

As well, it should be appreciated that the camera assembly 208h may be vertically moved along the direction of movement 209h in response to any command or manual movement. For example, the camera assembly 208h may be moved in response to a command from a remote computing device 204. As well, the camera assembly 208h may be moved along the direction of movement 209h in response to detecting a visitor. For example, the camera assembly 208h may be positioned in a retracted position, whereby the camera assembly 208h is located substantially within the security system as shown in FIGS. 13c and 13d. Accordingly, in response to the motion detector 218 detecting a visitor, the camera assembly 208h may then move to an extended position (as shown in FIG. 13d) to capture a greater vertical field of vision than in the retracted position. Moreover, the camera assembly 208h may be manually moved by a user.

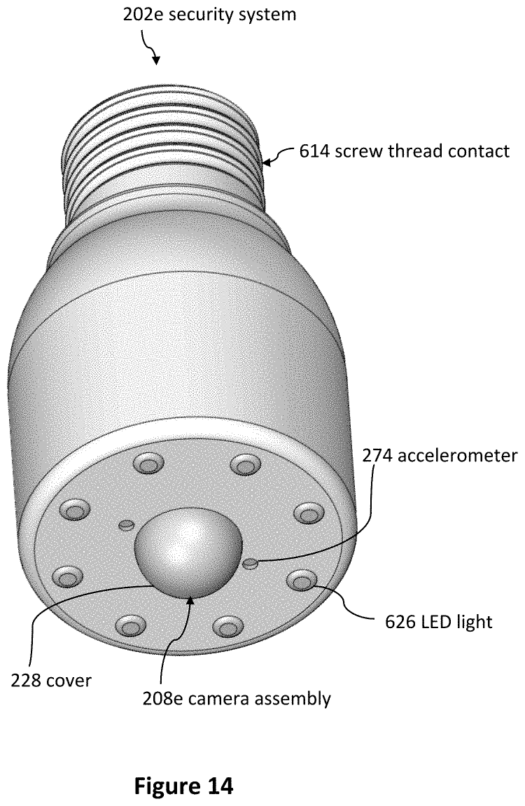

FIG. 14 illustrates a perspective view of the security system 202e from FIG. 13a. The dome camera assembly 208e can be used with any of the security systems described herein. The security system 202e can include lights (e.g., LEDs) on an end that is opposite the end that includes the screw thread contacts 614.

Any of the security systems described herein can use the methods and systems described in U.S. Nonprovisional patent application Ser. No. 14/463,548; filed Aug. 19, 2014; and entitled DOORBELL COMMUNICATION SYSTEMS AND METHODS; the entire contents of which are incorporated herein by reference. For example, the grid sensor methods can be used with security systems 202c, 202d, and 202e. The security system embodiments described in U.S. Nonprovisional patent application Ser. No. 14/463,548 can be replaced with security systems 202c, 202d, and 202e. Security systems 202c, 202d, and 202e can be used in the context of the security systems described in any of the patent applications incorporated by reference.

### Viewing Perspective

Many of the camera assemblies described herein can be mounted in diverse orientations. The mounting orientations might not be ideal viewing orientations. Embodiments can include changing the viewing orientations (e.g., viewing angles) via software (e.g., an “app”) and/or via a user interface 240 on a display screen 242 of a computing device 204 (see FIG. 2).

Cameras can be mounted in a lamp, jutting out of a wall (e.g., horizontally), and upside down (e.g., hanging down from a ceiling). The software and/or user interface 240 can enable users to select a button to adjust the viewing orientation a certain amount (e.g., 90 degrees).

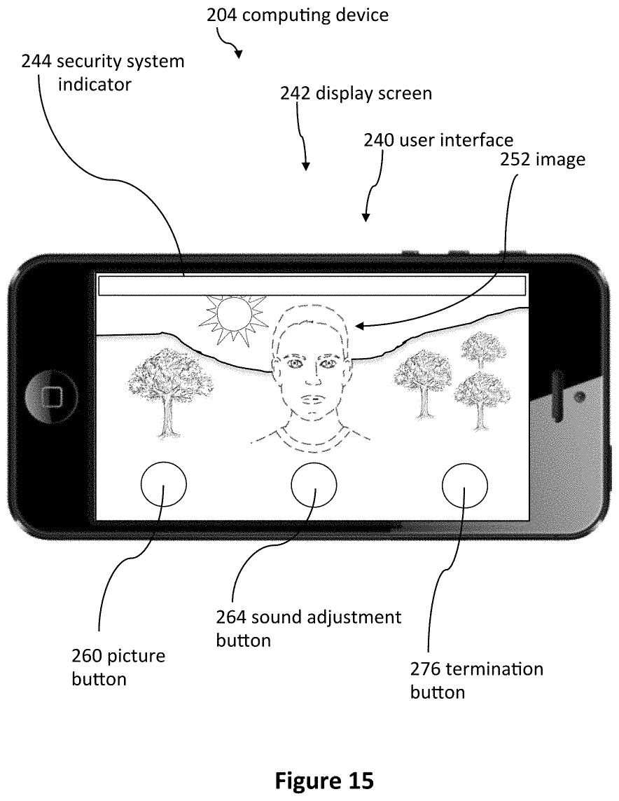

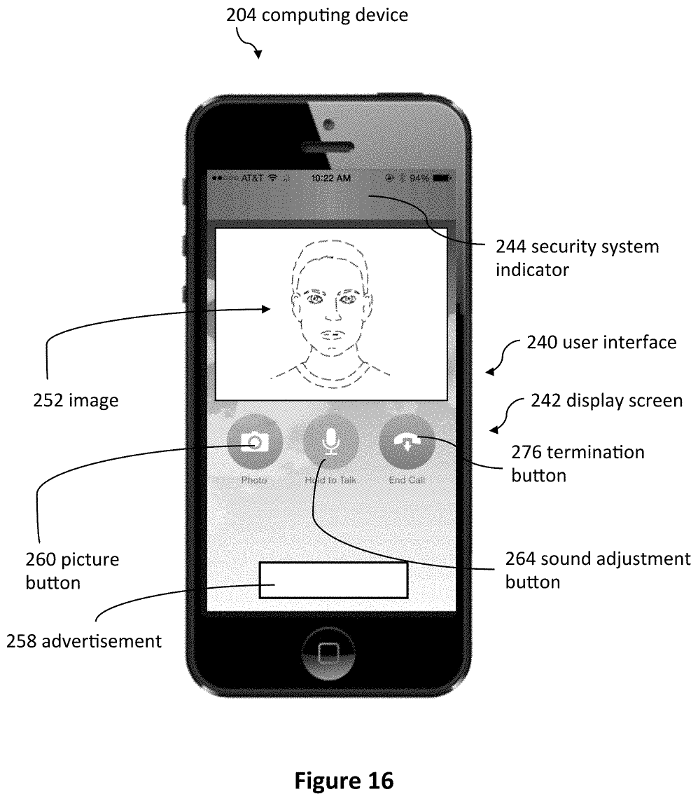

FIG. 15 illustrates a user interface 240. The image 252 in FIG. 15 is oriented as a landscape, which can span entire viewing portion of the display screen 242 of the remote computing device 204. The user can adjust the viewing orientation by selecting an orientation button (not shown), or simply by rotating the remote computing device 204 to the position of the desired orientation (e.g. if you want to view portrait, just the remote computing device rotate by ninety degrees as shown in FIG. 16). Accordingly, in some embodiments, selecting the orientation button shifts the image 252 ninety degrees. FIG. 16 illustrates the new orientation of the image 252 after selecting the orientation button, or rotating the remote computing device 204 to the desired orientation.

In some embodiments, the security system automatically detects the orientation in which the camera is inserted into a light socket. The security system can then automatically adjust the viewing orientation in response to the detected orientation (e.g., so the image 252 appears right-side up). The security system can detect the inserted orientation via an accelerometer 274.

### Visitor Identification Embodiments

Many embodiments may utilize the visitor identification abilities of the person using the remote computing device 204 (shown in FIG. 1a). Various technologies, however, can be used to help the user of the remote computing device 204 to identify the visitor. Some embodiments use automated visitor identification that does not rely on the user, some embodiments use various technologies to help the user identify the visitor, and some embodiments display images and information (e.g., a guest name) to the user, but otherwise do not help the user identify the visitor.

Referring now to FIG. 1a, the camera assembly 208 can be configured to visually identify visitors through machine vision and/or image recognition. For example, the camera assembly 208 can take an image of the visitor. Software run by any portion of the system can then compare select facial features from the image to a facial database. In some embodiments, the select facial features include dimensions based on facial landmarks. For example, the distance between a visitor's eyes; the triangular shape between the eyes and nose; and the width of the mouth can be used to characterize a visitor and then to compare the visitor's characterization to a database of characterization information to match the visitor's characterization to an identity (e.g., an individual's name, authorization status, and classification). Some embodiments use three-dimensional visitor identification methods.

Some embodiments include facial recognition such that the camera assembly 208 waits until the camera assembly 208 has a good view of the person located near the security system 202c and then captures an image of the person's face.

Several embodiments can establish a visitor's identity by detecting a signal from a device associated with the visitor (e.g., detecting the visitor's smartphone). Examples of such a signal include Bluetooth, WiFi, RFID, NFC, and/or cellular telephone transmissions.

Furthermore, many embodiments can identify an identity of a visitor and determine whether the visitor is authorized to be located in a predetermined location. For example, the light socket 650 may be located in a room inside a building 300. The security system 202c can determine whether the visitor is authorized to be located in the room. In response to determining that the visitor is not authorized to be located in the room, the security system 202c can transmit an alert to the remote computing device 204 to notify a user of the remote computing device 204 that the visitor is not authorized to be located in the room.

In some embodiments, the security system 202c may be located outside of a building 300, for example, near a swimming pool. Accordingly, the security system 202c may be used to determine the identity of the visitor and thereby determine whether the visitor is authorized to be located near the swimming pool. This may allow the user to monitor the swimming pool to determine if small children and/or any other unauthorized people approach the swimming pool. In effect, the security system 202c can be used as a safety monitor.

Furthermore, the security system 202c can also sound an audible message to warn the visitor that he or she is not authorized to be located in the room or outdoor area (e.g. swimming pool). For example, in response to determining that the visitor is not authorized to be located in the room or outdoor area, the security system 202c may broadcast a predetermined audible message, via the speaker 236 in the security system 202c, to notify the visitor that the visitor is not authorized to be located in the room or outdoor area. The security system 202c may also be configured to allow the user of the remote computing device 204 to speak to the visitor that is not authorized to be located in the room or outdoor area. For example, if the user's child has approached the swimming pool, the user may speak a message into the remote computing device 204, which may then be transmitted to the security system 202c and sounded via the speaker in the security system 202c (e.g. “Mitch, you are not allowed to be in the swimming pool after dark.”).

Embodiments of the security system 202c, may also save a history of times when the visitor was detected in the room or outdoor area by the security system 202c. It should be appreciated that this may also be used for a variety of purposes. For example, the user may have a dog walker walk the user's dog when the user is gone at work. In this manner, the security system 202c may be configured to save a history of times when the dog walker arrives at the building 300, which may allow the user may be able to oversee and determine if the dog walker is walking the user's dog as promised. This may be helpful when the user pays the dog walker's invoice. The user can review the history to determine whether the dog walker's visits to the buildings match the invoiced dates. The person of ordinary skill in the art will recognize a variety of situations to utilize this technology.

As well, the security system 202c may take action in response to determining that the visitor is authorized to be located in the room. For example, the security system 202c may transmit a second alert to the remote computing device 204, wherein the second alert notifies the user of the remote computing device 204 that the visitor is located in the room. In some embodiments, the second alert may also notify the user of the remote computing device 204 that the visitor is authorized to be located in the room.

In order to determine the identity of the visitor, the security system may utilize any technology capable of identifying a person or a remote computing device, such as facial recognition of a visitor, near field communication of a remote computing device 204 (e.g. identifying a remote computing device 204 associated with the visitor via Bluetooth), and the like.

### Methods of Detecting Visitors

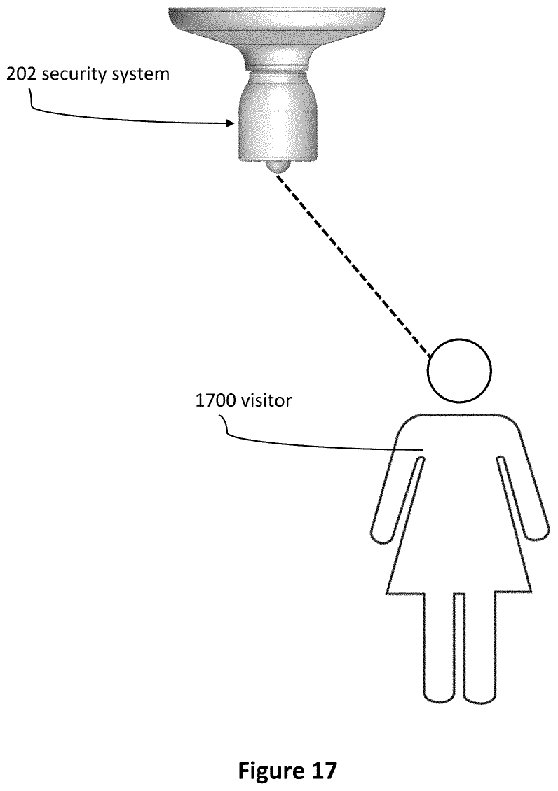

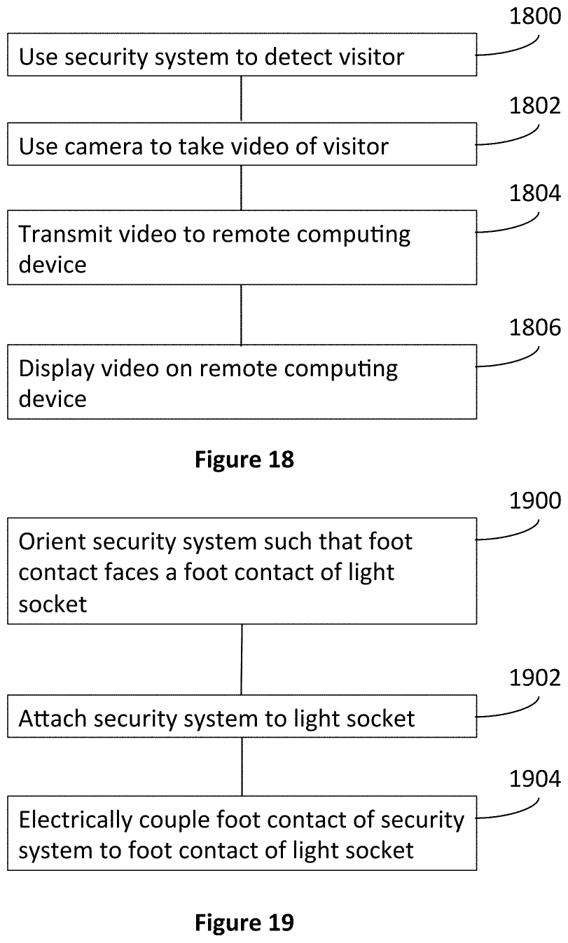

It should be appreciated that this disclosure includes a variety of methods of using the security system to detect visitors, like the visitor 1700 shown in FIG. 17. For example, as illustrated in FIG. 18, some methods include using the security system 202 to detect a visitor (at step 1800), and using the camera to take video of the visitor (at step 1802). As well, some embodiments include transmitting the video to a remote computing device 204 (at step 1804) and displaying the video on the remote computing device 204 (at step 1806). This may effectively allow a remote user to monitor the activity around the security system 202.

As shown in FIG. 19, some methods may include orienting the security system 202 such that the foot contact 618 of the security system 202 faces a foot contact 654 of the light socket 650 (at step 1900). FIG. 19 further illustrates a method that may include attaching the security system 202 to the light socket 650 (at step 1902) and electrically coupling foot contact 618 of the security system 202 to the foot contact 654 of the light socket 650. This electrical coupling may thereby energize the security system 202 to power all of the onboard components.

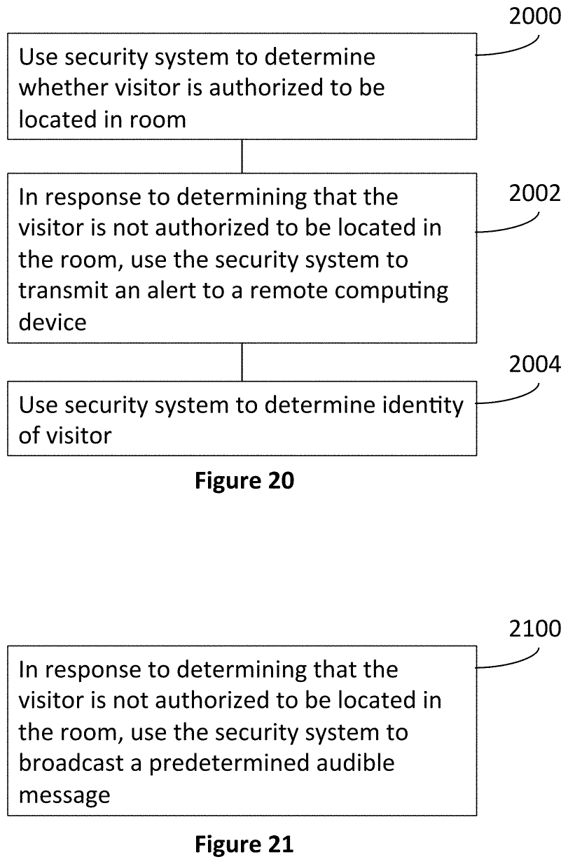

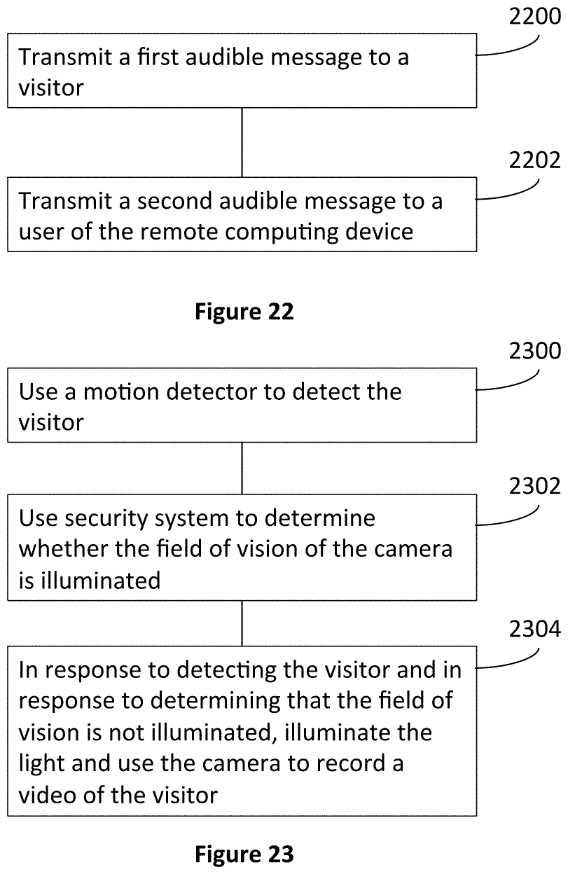

FIG. 20 shows a method that includes using the security system 202 to determine whether the visitor is authorized to be located in a room or in a space that the security system 202 is monitoring (at step 2000). In response to determining that the visitor is not authorized to be located in the room or the space, the method may further include using the security system 202 to transmit an alert to a remote computing device 204 (at step 2002). The alert may be a warning message, such as a text message or email, which warns the user that the unauthorized visitor is located in the room or space. Accordingly, some methods may further include using the security system 202 to determine the identity of the visitor, for example, via facial recognition or detecting a smart phone through NFC (at step 2004). As well, the identity of the visitor may be included in the alert that is sent to the remote user. For example, if the security system detects an unauthorized user, such as a toddler, near a swimming pool, the alert might say, “Timmy is located near the pool.”

As shown in FIG. 21, in response to determining that the visitor is not authorized to be located in the room or space, such as near or in the swimming pool, some methods may further include using the security system to broadcast a predetermined audible message (at step 2100). Using the example in the previous paragraph to further illustrate, when the security system 202 detects the toddler near the swimming pool, the security system 202 might sound an audible message via the speaker 236, such as, “PLEASE MOVE AWAY FROM THE POOL!”

Various methods may enable the visitor and remote user to communicate to each other through the security system 202. For example, some methods may include transmitting a first audible message to a visitor (at step 2200). In execution, the first audible message may be received by a microphone 234 in the remote computing device 204 and transmitted to the security system 202. As well, the first audible message may be audibly transmitted to the visitor via the speaker 236 in the security system 202. As well, methods may include transmitting a second audible message to a user of the remote computing device 204 (at step 2202). The second audible message may be received by the microphone 234 in the security system 202 and transmitted to the remote computing device 204. The second audible message may be audibly transmitted to the user via a speaker 236 in the remote computing device 204.

As well, methods may include using the motion detector 218 to detect the visitor (at step 2300) and using the security system 202 to determine whether the field of vision of the camera is illuminated (at step 2302). In response to detecting the visitor and in response to determining that the field of vision is not illuminated, the method may further include illuminating the light 626 and/or 630 and using the camera 208 to record a video of the visitor (at step 2304).

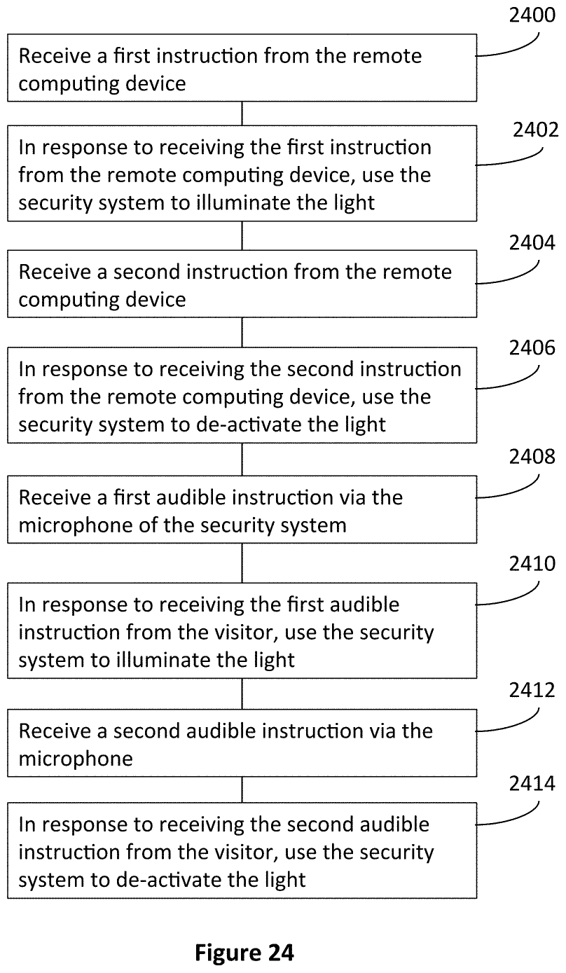

As illustrated in FIG. 24, methods may include receiving a first instruction from the remote computing device (at step 2400). In response to receiving the first instruction from the remote computing device 204, methods may include using the security system 202 to illuminate the light (at step 2402). As well, some methods may include receiving a second instruction from the remote computing device 204 (at step 2404). In response to receiving the second instruction from the remote computing device 204, methods may include using the security system 202 to de-activate the light 626 and/or 630 (at step 2406). Methods may also include receiving a first audible instruction via the microphone 234 of the security system 202 (at step 2408), and in response to receiving the first audible instruction from the visitor, the method may include using the security system 202 to illuminate the light 626 and/or 630 (at step 2410). As well, some methods may include receiving a second audible instruction via the microphone 234 of the security system 202 (at step 2412) and in response to receiving the second audible instruction from the visitor, the method may include using the security system 202 to de-activate the light 626 and/or 630 (at step 2414).

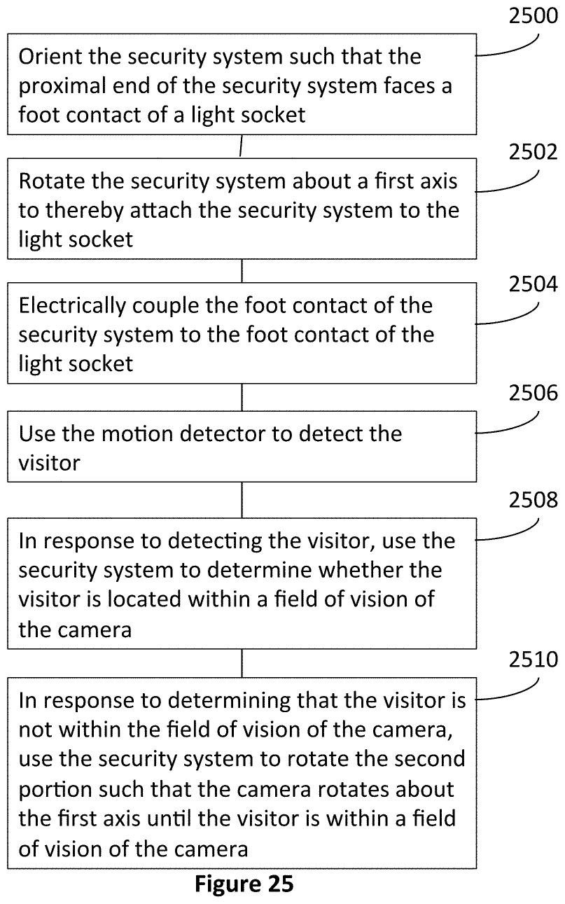

FIG. 25 illustrates a method that includes orienting the security system 202 such that the proximal end 280 of the security system 202 faces a foot contact 654 of a light socket 650 (at step 2500) and thereby rotating the security system 202 about a first axis 266 to thereby attach the security system 202 to the light socket 650 (at step 2502). The method may also include electrically coupling the foot contact 618 of the security system 202 to the foot contact 654 of the light socket 650 (at step 2504). Methods may include using the motion detector 218 to detect the visitor (at step 2506) and in response to detecting the visitor, the methods may include using the security system 202 to determine whether the visitor is located within a field of vision 238 of the camera 208 (at step 2508). In response to determining that the visitor is not within the field of vision 238 of the camera 208, methods may include using the security system 202 to rotate the second portion such that the camera 208 rotates about the first axis 266 until the visitor is within a field of vision 238 of the camera 208 (at step 2510).

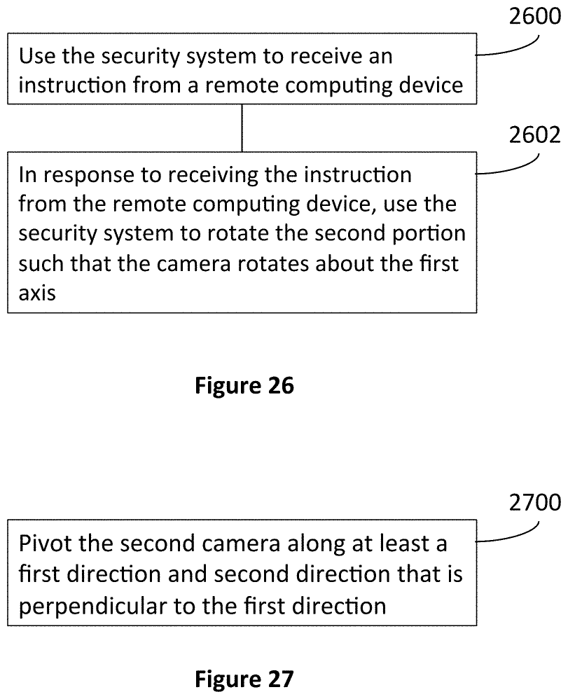

Furthermore, as shown in FIG. 26, methods may include using the security system 202 to receive an instruction from a remote computing device 204 (at step 2600). The instruction may comprise a command to rotate the second portion, or camera rotatable housing 658. In response to receiving the instruction from the remote computing device 204, the method may include using the security system 204 to rotate the second portion such that the camera 208 rotates about the first axis 266 (at step 2602). As well, as illustrated in FIG. 27, some methods may include a first and second camera, and the methods associated may thereby include pivoting the second camera along at least a first direction and a second direction that is perpendicular to the first direction (at step 2700).

### Detecting Adverse Sounds

The security system 202, or light socket camera, may also be configured to monitor a space by audibly detecting various sounds within the space. The sounds may be adverse sounds, which may include breaking glass, gunshots, shouting, screaming, and the like. In response to detecting the adverse sound(s) via the microphone 234, the security system 202 may be configured to notify a party of the adverse sound(s). It should be appreciated that the adverse sound may comprise any type of sound to indicate that someone or something is in need of help, that a problem has occurred, a crime is being committed, and the like.

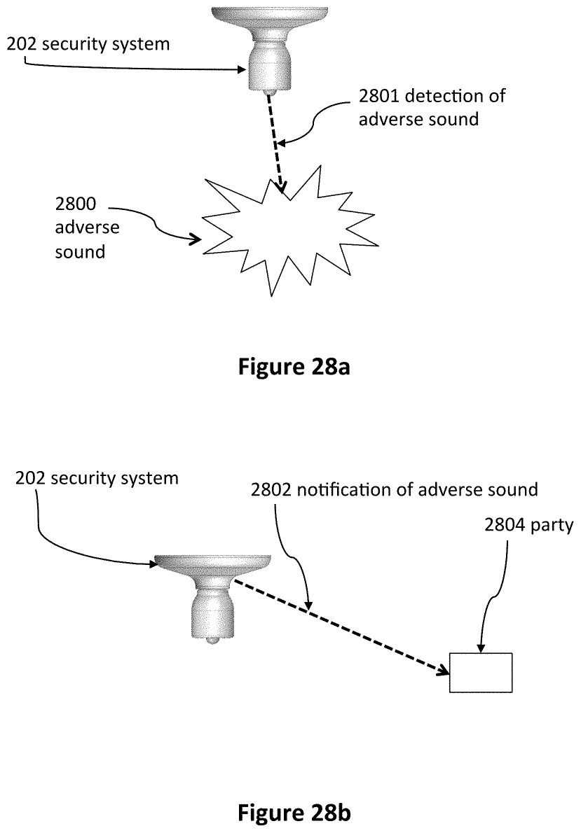

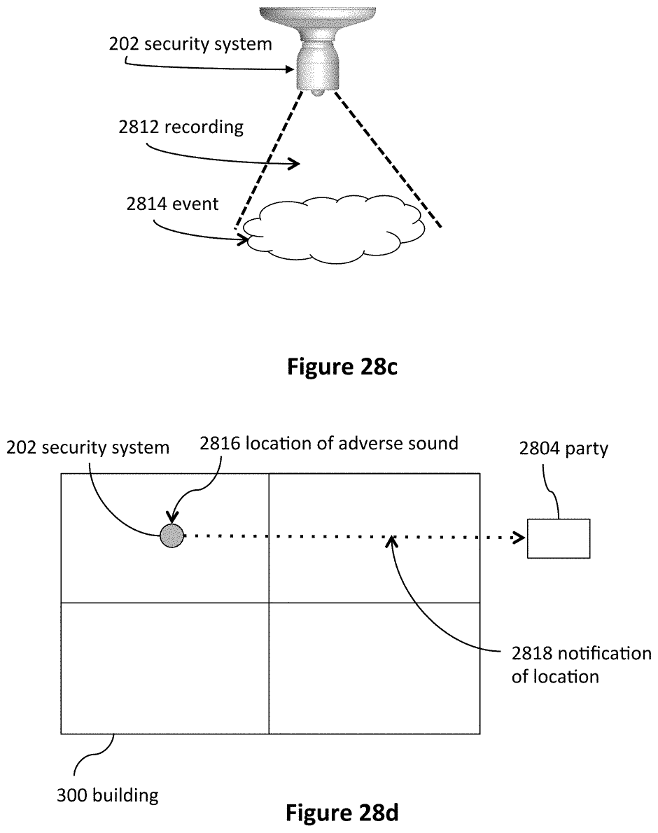

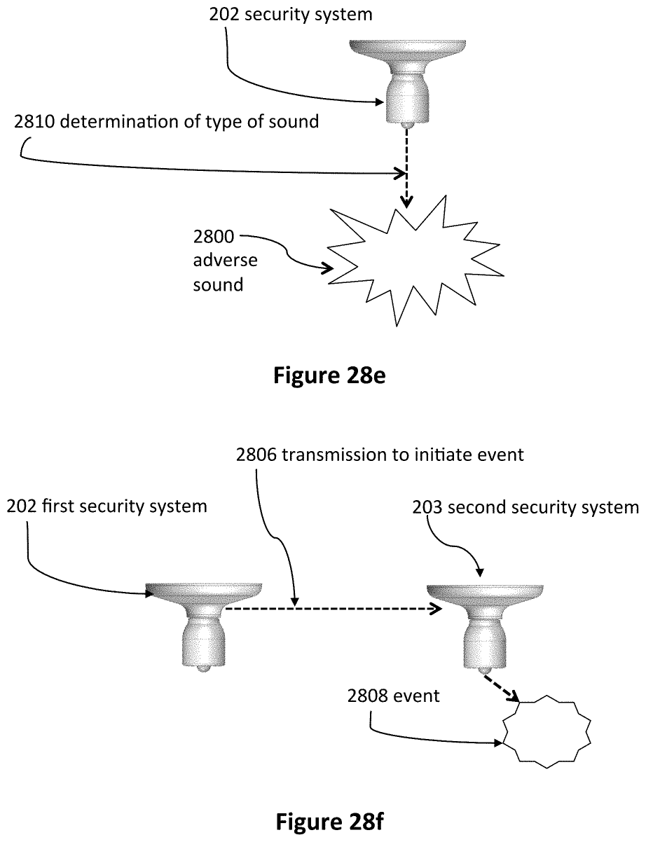

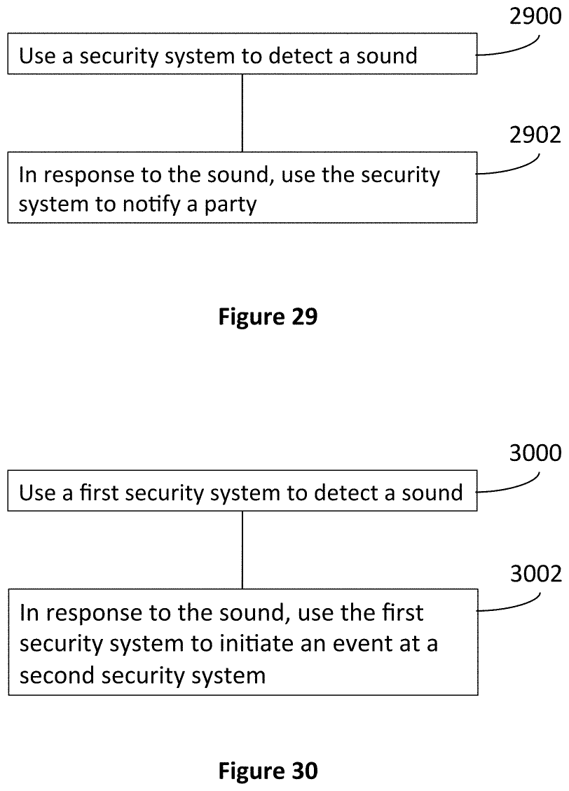

As illustrated in FIGS. 28a, 28b, 29 and 30, the disclosure includes a method for detecting an adverse sound 2800 (at step 2900). In response to detecting 2801 the adverse sound 2800, the method may include using the security system 202 to notify a party 2804 (at step 2902). The party 2804 to be notified may be any party that a user of the security system 202 may wish to contact, such as the user herself, or any contact listed on the user's contact list, such as a contact list stored within the user's remote computing device 204. As well, the party 2804 may be an emergency dispatcher, such as a 9-1-1 dispatcher (in the U.S.) or a dispatcher who responds to any emergency (in the U.S. or any other country). Generally, it should be appreciated that the party 2804 may be any party who may be interested in the occurrence of the adverse sound 2800.

The security system 202 may notify the party 2804 by sending a notification from the security system 202 to a computing device 204 associated with the party 2804. The security system 202 may transmit the notification through any wireless or wired technology. For example, the computing device 204 may receive the notification via a wireless technology such as radio frequency, WiFi (e.g., wireless local area network), cellular, Internet, Bluetooth, telecommunication, electromagnetic, infrared, light, sonic, and microwave. In this manner, the security system 202 may wirelessly communicate with the computing device 204 via the communication module 262 of the security system 202, which may be configured to connect to a wireless communication network. Furthermore, the security system 202 may transmit the notification through a wired technology, such as through the copper wires within the building 300, which may comprise a wired network. As well, the wired technology may include fiber-optics, Ethernet, telephone (e.g. digital subscribe line “DSL”), cable, and the like. In various embodiments, the wired technology can include Power-line communications through a home network. Various standards may be used such as IEEE 1901 or HomePlug AV.

As well, in response to detecting the adverse sound 2800, the method may further include using the camera 208 of the security system 202 to record one of an audio and video of an area adjacent the security system 202. As shown in FIG. 28c, upon the security system 202 detecting the adverse sound, the security system 202 may then capture a video or an audio recording 2812 of an event 2814 in an area adjacent the adverse sound 2800. The video and/or audio may be entered as evidence for a criminal investigation, or to determine liability in the event of a personal injury lawsuit. Upon capturing one of the audio and/or video, the method may further include transmitting the audio and/or video to the remote computing device 204.

Aside from documenting the area adjacent the adverse sound 2800, the security system 202 may also audibly sound a warning message through the speaker 236. The warning message may be an audible warning to alert any person or animal within the area of the adverse sound 2800 to leave the area or perhaps that help is on the way. Once the warning message has been sounded, two-way communication may be conducted between a user of a remote computing device 204, who is remotely located from the adverse sound 2800, and a person or animal located nearby the adverse sound 2800. In this manner, if a person is hurt on the ground near where the adverse sound was detected, the user may alert the hurt person that help is en route. It should also be appreciated that in response to detecting the adverse sound 2800, the security system 202 may perform any other function such as flashing a warning light, perhaps to scare away perpetrators.

The security system 202 may also be configured to determine logistical information, which may be helpful to an emergency dispatcher. For example, in response to the adverse sound 2800, the security system 202 may determine a location of the adverse sound 2800 with respect to its location inside or outside of the building 300. In response to determining the location of the adverse sound 2800, the security system 202 may transmit a notification of the location 2818 of the adverse sound 2800 to the party 2804. This may be helpful to emergency personal in order to locate the site of the adverse sound 2800, which may indicate the location of the victim, perpetrator, etc. In another example, the security system 202 may interface with existing law enforcement gunshot location systems to better triangulate the position of a gunshot for law enforcement authorities, even if the gunshot did not occur within the vicinity. Components of the security system 202 may be customized depending on the primary application. For example, if detecting gunshots, then the microphone 234 may need increased microphone sensitivity in lower frequencies.

With reference to FIG. 28e, the method may include determining a type of the adverse sound 2800, such as determining whether the adverse sound 2800 comprises a gunshot, scream, etc. In this regard, the security system 202 may include an internal processor to digitally analyze the adverse sound 2800 to determine the type of adverse sound. In some embodiments, the security system 202 may transmit a digital signal, which represents the adverse sound 2800, to an external processor to be digitally analyzed to determine the type of adverse sound. Upon determining the type of adverse sound 2800, the type of adverse sound 2800 may then be communicated to the party 2804, via the remote computing device 204. It should be appreciated that the notification as sent to the remote computing device 204 may be a text message, a phone call (such as a pre-recorded message), or any type of communication that notifies the party 2804 of the adverse sound 2800 and/or the type of the adverse sound.

As well, the security system 202 may also be configured to determine other biographical information such as a time of day that the adverse sound 2800 was detected. In response to determining the time of day of the adverse sound 2800, transmitting a notification of the time of day to the party 2804.

As illustrated in FIG. 28f, methods may include interaction between two security systems, whereby a first security system 202 notifies a second security system 203 of the adverse sound 2800. For example, in response to detecting the adverse sound 2800, the method may include using the first security system 202 to initiate an event at a second security system 203 communicatively coupled to the first security system 202.

The second security system 203 may perform any event that may be performed by the first security system 202. For example, the second security system 203 may sound an audible message through a speaker 236 of the second security system 203. As well, the second security system 203 may flash a warning light, such as an LED, located on the second security system 203.

In response to either sounding the audible message or flashing the warning light, the second security system 203 may also be configured to use a motion detector of the second security system 203 to detect a motion of a user within an area of the second security system 203. In this manner, the first security system 202, via the second security system 203, may detect whether the user responds to the event or notification of the adverse sound 2800 as detected by the first security system 202. If the second security system 203 does not detect motion of the user, the first security system 202 may initiate other events, such as an event at a third security system, not shown, or an event at a remote computing device 204, such as a text message at a remote computing device 204. The first security system 202 may continue initiating events until the first security system 202 receives confirmation that a user is aware of the adverse sound 2800 as detected by the first security system 202.

The second security system 203 may also audibly project, via the speaker 236, specific information relating to the adverse sound 2800 as detected by the first security system 202. As such, the first security system 202 may be communicatively coupled to the second security system 203, and the first security system 202 may communicate information to the second security system 203, such as the type of adverse sound 2800, the location of the sound, time, etc. For example, in response to a window pane being broken at a back door, the second security system 203 may project a message, “Broken glass detected at the back door!” In this regard, the second security system 203 may notify a user of the type of adverse sound detected, and also the location of the adverse sound.

As well, because the first security system 202 may be configured to determine and distinguish various types of sounds, the first security system 202 may also initiate specific events in response to the type of sound detected. For example, the security system 202 may determine whether the adverse sound 2800 is a first sound or a second sound. In response to determining the adverse sound 2800 is the first sound, the first security system 202 may be configured to initiate a first event at the first security system 202 and/or the second security system 203. In response to determining the adverse sound 2800 is the second sound, the first security system 202 may be configured to initiate a second event at the first security system 202 and/or the second security system 203. It should be appreciated that the second event may be different than the first event. For example, the first sound may be a shouting noise and the first event may comprise flashing a warning light of the first security system 202 and/or the second security system 203. As well, the second sound may be breaking glass and the second event may comprise sounding an audible alarm.

Generally, it should be appreciated that the first security system 202 may be configured to perform specific events in response to specific adverse sounds, as well as instructing the second security system 203 to perform specific events in response to detecting specific adverse sounds.

Moreover, in response to the first security system 202 detecting a first adverse sound, such as crashing noise, the first security system 202 may transmit a text message to the remote computing device 204 to notify the user of the first adverse sound. In response to the first security system 202 detecting a second adverse sound, such as a gunshot, the first security system 202 may notify an emergency dispatcher of the second adverse sound. Generally, in response to any type of adverse sound 2800, the first security system 202 may be configured to perform any of the actions described throughout this disclosure.

### Detecting Audible Notifications

Methods may include detecting audible notifications and establishing communication between two parties via the security system 202. The security system 202 may also be configured to respond to communication between the two parties in the event of a distress notification.

In some embodiments, the security system 202 may have a detection system that uses the microphone 234 to record a noise and to monitor for an audible notification. The security system 202 may monitor the environment for the audible notification as a passive activity. For example, the security system 202 uses the microphone 234. The microphone 234 may record sounds at a particular sampling frequency (i.e., the number of times within a defined window of time that a sound is recorded) for a particular duration. The sampling frequency and duration for monitoring the environment may change depending on the preferences of a user. For example, the security system 202 can monitor for an audible notification every second in order to be responsive to a first party. The monitoring may also be restricted during times of the day to save resources. The security system 202 may reduce the sampling during times when residents are not present. For example, when most residents are not at home (e.g., between the hours of 9 AM to 5 PM), the security system 202 can collect audio data less (e.g., every 2 minutes for 10 seconds) frequently than time periods when residents are at home.

The audible notification may include multiple parts such as an audible prompt and a voice command. The audible prompt can be a phrase that prompts the security system 202 to receive the voice command. The audible prompt can also be a series of non-word sounds such as the humming of a song. The audible notification can also include a voice command. One possible voice command can include instructions for the light socket surveillance system to contact the second party. This voice or audible command can be a phrase that is a series of commands that instruct the security system 202 for further action. For example, the voice command can be “call for help”, and the security system 202 may call a number associated with the voice command, for example, an emergency dispatch (e.g. 911) or an emergency contact (e.g. a spouse). The voice commands can be responsive to commands selected from a dictionary of defined commands or can be interpreted based on the context. For example, message, call, and phone, may be used interchangeably. Other synonyms can be determined based on a language thesaurus.

The dictionary of defined commands may be preassigned. For example, the dictionary may be static depending on the security system 202. In embodiments, the dictionary is dynamic and can incorporate new commands based on usage. For example, if a first party typically uses the command “Phone second home”, then the security system 202 can ask the first party if the first party desires to add the word “phone” to the voice command dictionary. The security system 202 can then ask whether the “phone” command is equivalent to the “call” command. Each instance of these preferences from the first party may be added to a configuration profile of the first party.

Generally, the audible notification may be various frequencies of a human voice. For example, the audible notification may include a person speaking a selected sequence of words. For example, the sequence of words, “Hi Max,” may be the audible prompt. The selected sequence of words may be predetermined upon a setup of the security system 202. The security system 202 may have various profiles selected for members of a household. The security system 202 can have selected sequences of words and voice recognition for each profile. For example, the security system 202 may be configured to detect an audible prompt from a first resident that has the word “Max”, while the audible prompt from the second resident may have the word “Jimmy”. As well, the security system 202 may be configured to respond to one name or word from any resident. For example, the first and second residents may use the phrase, “Hi Max,” which triggers the security system 202 to respond. Generally, it should be appreciated that any word or sequence of words can be used to prompt the security system 202.

As a security precaution, speaker recognition may be implemented by the security system 202. For example, the security system 202 may utilize a combination of frequency estimation, hidden Markov models, Gaussian mixture models, pattern matching algorithms, neural networks, matrix representation, vector quantization, or decision trees.

Additionally, the security system 202 may determine whether the audible notification is present. The security system 202 may have a margin of error in both the speaker identity and the speech recognition. In various implementations, the security system 202 may utilize a threshold for both the speaker identity and speech recognition. For example, if the security system 202 determines a 90% match for the word “Computer”, but only a 20% match for the identity of the speaker for the profile, and the threshold is a 60% match for identity, then the security system 202 determines that there is no audible notification. In embodiments, the audible notification can be interchangeable for different profiles. For example, the first resident may have an audible prompt of “Max” while the second resident may have an audible prompt of “Jimmy”. The first resident may use the same audible prompt as the second resident and the security system 202 may recognize the audible prompt for both.

The security system 202 may determine whether there is a secondary notification present. The secondary notification may be determined by any input, for example, auditory, visual, chemical sensing, or tactile. Thus, the secondary notification may be a hand waving motion sensed by a camera assembly 208. For example, the secondary notification can be an image of the first party reaching up at the camera or gesturing to call the second party. Various gestures may be programmed into the security system and calibrated by the first party. The secondary notification may include various smells determined by a chemical sensor (e.g., perfume to detect the presence of a particular person, or a carbon monoxide sensor to detect fire). The secondary notification may include the first party striking a wall multiple times which may cause pressure-sensitive sensor assembly of the security system 202 to read a particular pattern of the striking.

The secondary notification may also be audio-based. An audio-based notification may be different than an audible notification in that the secondary notification is not a recognized voice command or audible prompt. For example, the secondary notification can be a distress call (e.g., a groan, moan, scream, or crying). The secondary notification can also be calibrated with environmental sounds. For example, a baby crying may be vocally distinguishable from a cry for help from an adult. The security system 202 can use calibrated settings from the first party or a library of sound profiles that indicate distress. Certain words, when used in repetition, may also indicate a secondary notification such as “Help help help!” The security system 202 may store the sound profiles locally for fast access or access the sound profiles remotely.

The security system 202 can further determine whether the first party is in distress. This step may be optional depending on the configuration on the security system 202. In embodiments, a distress notification is an indication that the first party is injured and requires assistance. The distress notification can be in addition to the audible notification and may be part of the audible notification. The security system 202 may determine that a party is in distress based on elevated vital signs that typically indicates stress in humans. For example, an elevated pulse may indicate stress of a party. An elevated pulse may be monitored through an infrared camera on the security system 202 that is configured to monitor pulse rates and body temperatures. An elevated pulse may be monitored through a tracking device worn by the party. The tracking device can be configured to measure pulse rates and may sync the information over the wireless communication (e.g., Bluetooth™). Alternatively, the tracking device may be configured to communicate a medical emergency when the first party pushes a button. The tracking device may use existing wireless signals in the Industrial, Scientific, and Medical bands of frequencies (e.g., 916 Megahertz).

The security system 202 can also determine that a party is in distress based on the audio-based secondary notification. For example, if the secondary notification is a scream, which typically indicates distress, then the security system 202 can determine that the first party is in distress. The security system 202 may determine that a party is in distress based on fluctuations in the voice of the first party. For example, variations in tone or cadence of a voice may indicate distress at any point in the audible notification. In embodiments, the security system 202 may also monitor the volume, pitch, and cadence of speech in a time period before the party attempts an audible notification. As mentioned herein, the secondary notification may also indicate distress via certain words or sounds. The distress of a party may also be determined by the lack of activity. For example, if the pulse rate or blood pressure of the first party is reduced, then the security system 202 may determine the first party is distressed. Alternatively, the security system 202 may also use the camera to analyze the environment. If the party is lying face down on the floor versus a couch, then this may indicate that the party is in distress.

The security system 202 may trigger the recording of the environment as discussed further herein. In embodiments, the security system 202 may continuously record data from the security system 202 whether the first party is in distress or not. Otherwise, the security system 202 recording may be triggered by the party being in distress.

The security system 202 may use the camera to record at least one of an image and video. For instance, the detection system of the security system 202 includes the camera 208. Various implementations of the security system 202 include a camera 208 mounted on a sidewall. For example, the sidewall may include a first portion and a second portion that is rotatable with respect to the first portion and the camera 208 is coupled to the second portion. The security system 202 may determine whether the first party is located within a field of view of the camera. The security system 202, in response to detecting the audible notification and in response to determining that the first party is not located within the field of view of the camera may use the light socket surveillance system to rotate the second portion until the first party is located within the field of view of the camera. Once in the field of view of the camera, the security system 202 can use the camera 208 to record at least one of an image and video and initiate a transmission of at least one of the image and video to a remote computing device associated with the security system 202.

In response to detecting the audible notification from the first party, the security system 202 may contact a second party. The security system 202 can use various protocols to connect the first party with the second party. For example, telephone communications, cellular network communications, and Voice over IP may be utilized to connect the audio between the first party and the second party. The security system 202 may also be configured to establish both video and audio communications between the first party and the second party. The video can utilize a different communication channel than the audio channel. For example, the audio communication can occur over a wired telephone network while the video communication can occur over a wireless network that further connects to the Internet. In embodiments, communication can be performed over the Internet via data packets using various schemes (e.g., H.264 Scalable Video Coding, cloud-based video conferencing, etc.).

In some embodiments, the security system 202 may exchange the readings of the security system 202 with a second party. The detection system of the security system 202 can use the speaker and the microphone to allow the first party and the second party to audibly communicate in real-time. The second party can further ask questions to more accurately determine the status of the first party. For example, the first party and the second party can hold a conversation discussing the events of the day or the second party can inquire as to the state of well-being of the first party if the security system 202 detected distress. The second party can be notified whether the user was in distress and what secondary notifications were present.

In embodiments, the security system 202 can initiate a transmission of the noise to a remote computing device associated with the second party. Thus, the second party may also be a remote computing device. The remote computing device may be a computer that monitors various video and audio streams of the security system 202. For example, the second party may be a security monitoring company, and the remote computing device can be a server that alerts security officers via an application mobile device. The remote computing device can initiate a transmission of at least one of the image and video to a remote computing device associated with the second party. The remote computing device can further respond to image and video. For example, the remote computing device can receive the determination of distress from the security system 202 and dispatch emergency responders immediately to the home with the security system. The remote computing device may have additional capabilities beyond that of the security system 202 such as remote storage, facial recognition, and voice recognition.

The security system 202 can monitor the communication between the first party and the second party. The security system 202 may be configured to detect whether a notification is present from the second party. The notification can be either an audible notification or a secondary notification as discussed herein. If the second party is a human, such as a relative or friend of the first party, then the second party may ascertain the state of health of the first party. The security system 202 can monitor the communication for various audible notifications in order to make it easier for the second party to take actions. For example, if the first party says, “I'm having chest pain and it's difficult to breath” with a second party, then the second party can indicate a variety of audible notifications such as the voice command “Call Ambulance” in order to trigger an action. The security system 202 may initiate a variety of actions. The security system 202 can notify the emergency services, but other types of actions are contemplated. For example, the security system 202 can also notify a neighbor or security officer to inquire further.

The security system 202 can also be configured to determine an identity of a party based upon any physical attribute, any noise, or any type of device that is associated with the person of the party. For example, the security system 202 can be implemented with any type of identity recognition system, such as voice recognition, which can be used to determine the identity of the party from a noise, such as a speech, scream, etc. Embodiments may be configured to detect and determine the identity of a remote computing device (e.g. Bluetooth™). In determining the identity of a remote computing device, this may determine the identity of the person associated with the remote computing device.

The first party can adjust the permission levels to account for emergency override of audible notifications for security system 202 users without a configuration profile (e.g., an emergency contact). In embodiments, the presence of the first party may allow the second party to initiate audible notifications. In the event of a non-speaking first party, a camera can verify the identity of the first party and contact a second party on an emergency contact address list. Thus, the emergency contact address list may also be a list of permitted individuals to use voice commands. It should be appreciated that the second party can be any party described herein such as a security officer, emergency dispatch, a friend, a family member (e.g. spouse), neighbor, coworker, and the like.

### Triggering Appliances

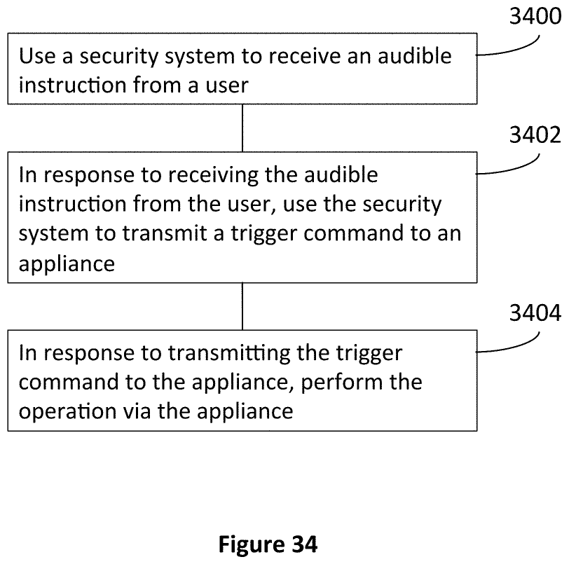

With reference to FIG. 34, the security system 202, or light socket camera, may further be configured to receive instructions from a user (at step 3400), such as an audible instruction, and thereby trigger an appliance to perform an operation. For example, the user may audibly instruct the security system 202 to turn on a television. In this manner, the security system 202 may be configured to respond to a predetermined greeting, such as, “Hi Max” or “Hey Max,” or a even predetermined name, such as, “Max.” Audibly speaking the predetermined greeting or name can instruct the security system 202 to perform (via itself) or transmit a command to another appliance (at step 3402) to perform anything stated after the predetermined greeting or name. In response to transmitting the trigger command to the appliance, the method can also include performing the operation via the appliance (at step 3404). For example, if a user audibly says, “Hi Max, please unlock the front door,” the security system 202 can transmit a command to a front door lock that is communicatively coupled to the security system 202. In response to the command being transmitted to the door lock, the door lock can then move to the unlocked position, or if the door lock is already in the unlocked position, the door lock can simply remain in that position.

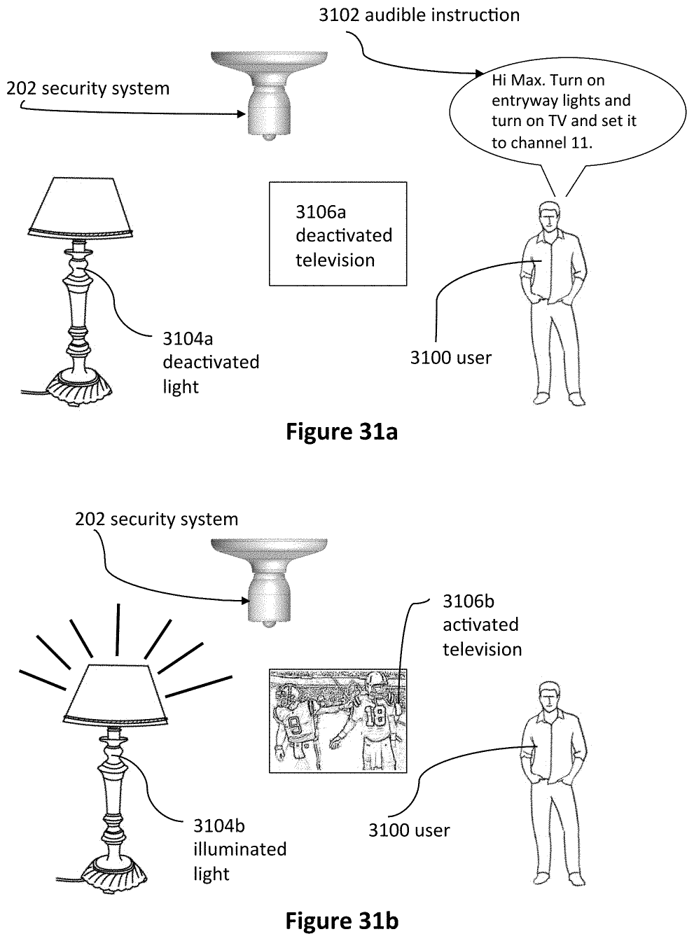

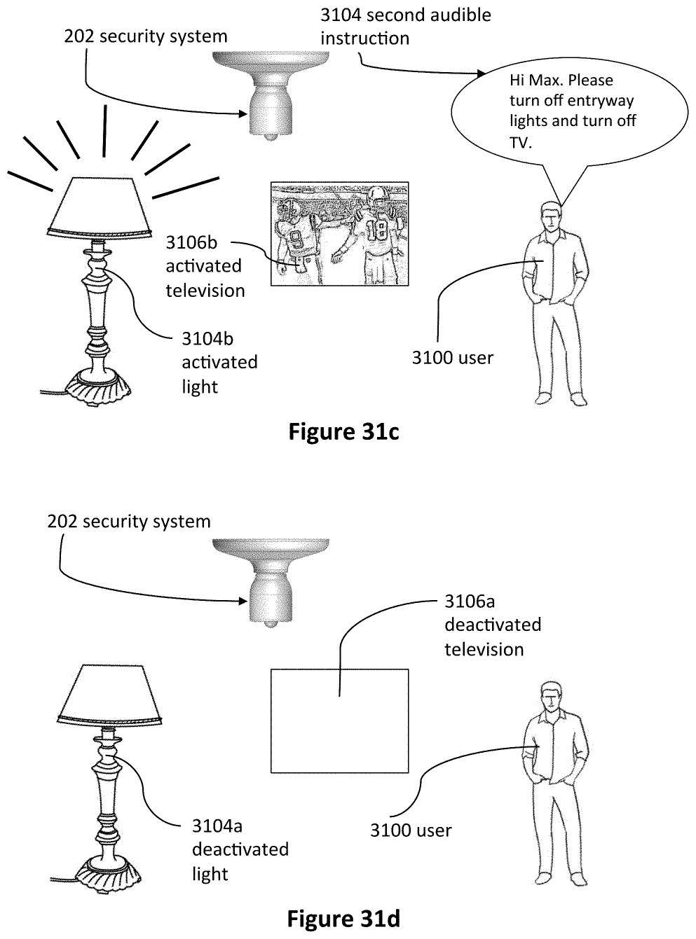

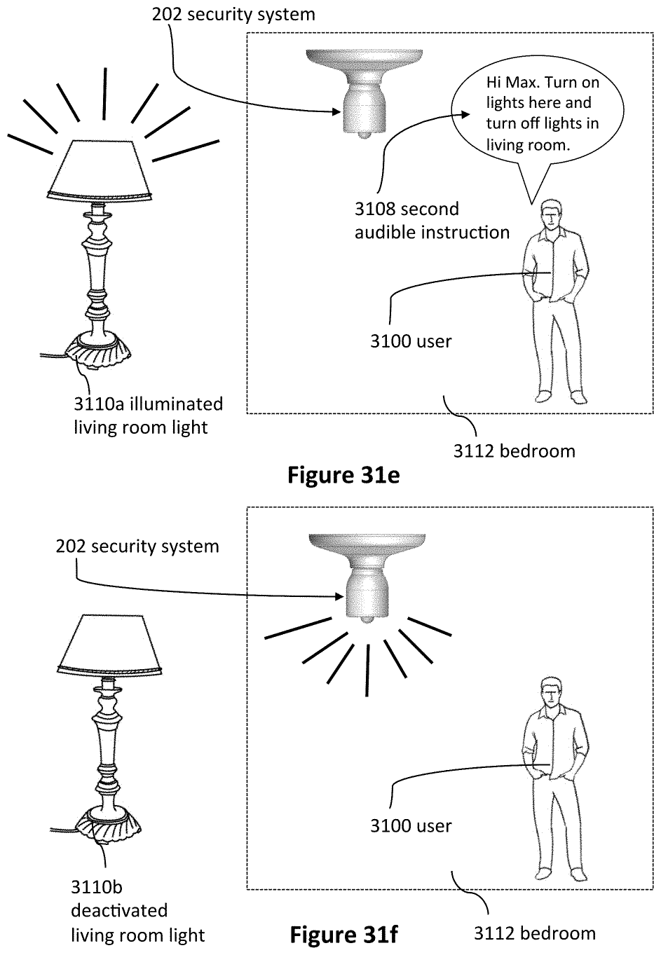

FIGS. 31a-31d illustrate just one of the many examples of how the security system 202 may be used to receive an audible instruction 3102 from a user 3100. As shown in FIGS. 31a and 31b, the user 3100 may audibly speak an instruction 3102, such as “Hi Max. Turn on entryway lights and turn on TV and set it to channel 11.” The audible instruction 3102 may be received by the security system 202, at which point it may transmit commands to various appliances. For example, the deactivated television 3106a may become activated (activated television 3106b) through a command sent via a wireless or wired connection to the television. Accordingly, the television 3106b may set it's input channel to channel 11, in response to the user's audible instruction 3102. As well, the deactivated light 3104a light may become illuminated 3104b via the command. Accordingly, the security system 202 may also deactivate the television 3106 and light 3104 as shown in FIGS. 31c and 31d.

Generally, it should be appreciated that the term “operation” can be broadly defined. For example, the term “operation” can include activate, deactivate, illuminate, begin, stop, end, change, pause, record, identify, run, make, detect, and the like. In this regard, the security system 202 can control any number of appliances to perform any type of operation that is within the normal use of the appliance.

Furthermore, the appliance can be any type of appliance that is communicatively coupled to the security system 202 via a wireless connection or a wired connection. For example, the appliance can be a light, lamp, shower, faucet, dishwasher, door lock, garage door opener, door, fan, ceiling fan, coffee maker, alarm clock, stereo, television, digital video recorder, cable box, digital video disc player, compact disc player, toaster, oven, range, microwave, streaming media player (such as Apple TV), HVAC system (heating, ventilating and air conditioning system), telephone, fax machine, shredder, blender, juicer, space heater, thermostat, camera (such as a nanny camera), power tool (such as a table saw, drill, chain saw, etc.), smoke alarm, a second security system 202 (such as a second light socket camera, or a security system that can be plugged directly into a wall outlet), and any appliance that may be electrically coupled to a building or any appliance that may be communicatively coupled to the security system 202. Specific examples of appliance operations may include closing and/or opening a garage door, turning on and/or turning off a television, pausing a television, setting an input channel of a television to any desired station, changing television volume, making a cup of coffee via a coffee maker, setting a thermostat to a predetermined temperature, unlocking and/or locking a door lock, and the like.

As shown in FIGS. 31e and 31f, the security system 202 may trigger appliances located in different places throughout the house. For example, the security system 202 may receive a second audible instruction 3108, and in response to the instruction 3108, the security system 202 may activate an appliance, such as a light on the security system 202, within the same room, such as bedroom 3112, and also another appliance, such as living room light 3110, located in a different room. In this regard, the security system 202 may be configured to control multiple appliances simultaneously, all the while the appliances may be located in the same location or different locations. As long as the appliances are communicatively coupled to the security system 202, then the appliance can be located anywhere.

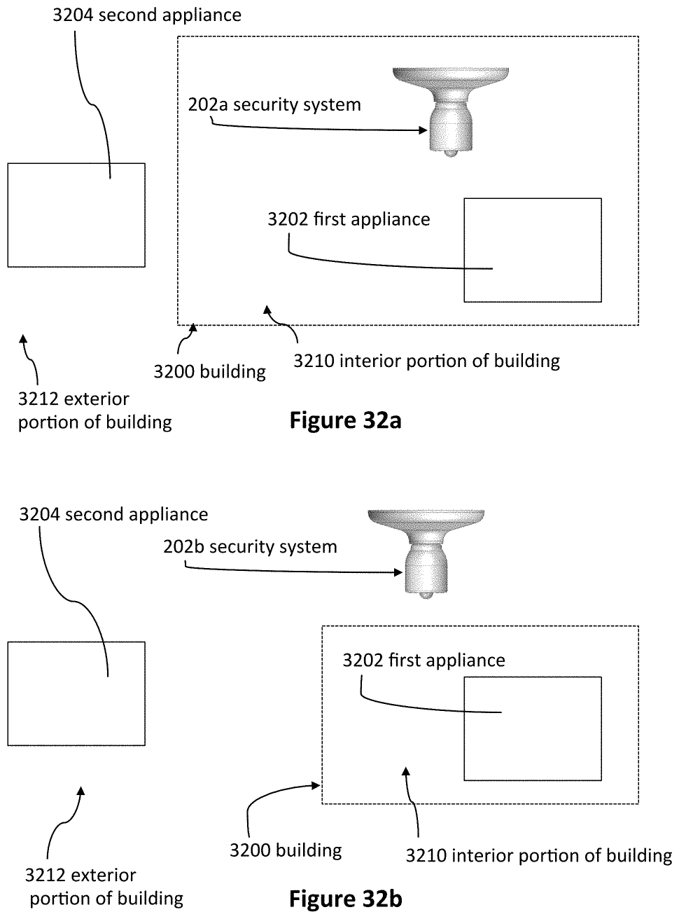

With reference to FIGS. 32a and 32b, the security system 202a may be located within an enclosed interior portion 3210 or along an exterior portion of the building 3212. In this manner, the security system 202 may trigger appliances 3202, 3204 located within the interior portion 3210 or exterior portion of the building 3212. As well, the security system 202 itself may be located within the interior portion of the building 300 or along the exterior portion of the building 300. Generally, and regardless of where the security system 202 is located, the security system 202 may be configured to simultaneously trigger appliances located inside the building, while also triggering other appliances located outside of the building 300.

Some embodiments of the security system 202 can be configured to trigger appliances after predetermined period of time has passed. For example, the user may audibly instruct the security system 202 to make a cup of coffee in five minutes. Accordingly, the security system 202 may wait five minutes before transmitting the command to the coffee maker. As well, some embodiments may be configured to determine how long it may take to make the cup of coffee and if the it takes two minutes to make the coffee, the security system 202 may transmit the command to the coffee maker in three minutes, which added together with the two minutes to make the coffee will equal five minutes total. However, this is just one of the many examples, and generally, it should be appreciated that the security system 202 may be configured to trigger any appliance after any amount of time and under any logical circumstances.

In some embodiments the security system 202 may be referred to as a first security system 202. In this manner, some embodiments also include triggering a second security system 202, such as a second light socket camera, to determine if another person is present in a different part of the building 300. For example, the user may instruct the first security system 202 to determine if another person is present in the kitchen. In response to receiving the audible instruction, the first security system 202 may to transmit a command to the second security system 202 to determine whether someone is located within the kitchen. In response to the command, the second security system 202 may use a camera to scan the room and determine whether a person is present. As well, the user may wish to determine the identity of a person that may be present. For example, the audible instruction may further include an instruction to determine an identity of the visitor. In response to determining that the visitor is located within the kitchen, the second security system may determine the identity of the visitor, via any identity detection technology such as facial recognition, iris recognition, retina scanning, smart phone detection, and the like.

Accordingly, the first security system 202 may also be configured to determine the identity of a user or visitor. This technology may be implemented to prevent unauthorized users from activating specific appliances. For example, a parent may restrict a child from watching television. In this manner, the child may not be authorized to watch television at specific hours or at any time of day. In effect, the child may audibly instruct the security system 202 to activate a television. The security system 202 may then determine the identity of the child as being an unauthorized user, and in response to this determination, the security system 202 may not activate the television in conformance with the child's instruction. Alternatively, if an authorized user, such as an adult, were to audibly instruct the security system 202 to activate the television, then upon determining that the adult is in fact an authorized user, the security system 202 may transmit a command to the television to thereby activate the television. It should be appreciated that this feature may be implemented with any desired appliance, such as dangerous appliances, like a power tool.

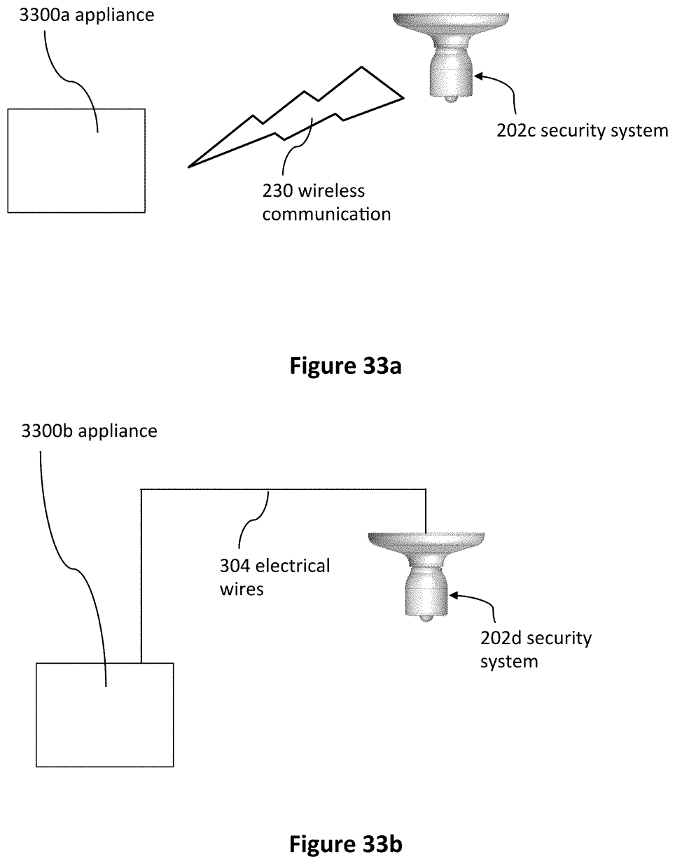

With reference to FIGS. 33a and 33b, the security system 202 may transmit commands to any of the appliances 3300a, 3300b via a wireless 230 or wired connection 304. For example, the security system 202 may use its communication module 262 to wirelessly 230 transmit the command to the selected appliance via one of Wi-Fi, Bluetooth, radio frequency, Near Field Communication, infrared, and any other wireless technology discussed in this disclosure.

As shown in FIG. 33b, security system 202 may use its communication module 262 to transmit the command to the appliance 3300a, 3300b via a wire 304 that is electrically and communicatively coupled to the security system 202. For example, the wired connection may comprise a copper wire located within the building 300. The copper wire may any type of traditional copper used for conducting electricity and WiFi throughout a building 300. However, it should be appreciated that the wired communication any type of wired technology as described in this disclosure, such as Ethernet, telephone, and the like.

In some embodiments the security system 202 may be communicatively coupled, via the Internet, to a remote server. In this manner, the security system 202 may communicate with the remote server to thereby transmit the desired command to the appliance via a media access control address (MAC address). In this manner, the remote server digitally encodes the command and transmits the command to the appliance, whereby the appliance performs the desired operation as audibly instructed by the user. Sometimes the Internet connection may be unavailable and the security system 202 may be unable to communicate with the remote server. Accordingly, the security system 202 may still communicate with the desired appliance by transmitting the command from the security system 202, to a WiFi router, and to the desired appliance. In this regard, the security system 202 is able to communicate to the appliance whether or not an Internet connection exists.

The situation may arise where the security system 202 is not communicatively coupled to the appliance within the building, or when the security system 202 is not electrically coupled to the building 300. In this regard, the security system 202 may perform a check to determine whether connectivity or electricity is available, and in response to determining the security system 202 is not electrically coupled to the building 300 (or communicatively coupled to the appliance), the security system 202 may illuminate a light on the security system 202 to thereby illuminate an area adjacent the light socket camera. The illumination of the light may be performed in response to the audible instruction from the user. However, in some embodiments the light on the security system 202 may automatically be illuminated in response to losing connectivity and/or electricity. This may helpful in the event of a power outage when people are trying to navigate their way around the building 300.

Embodiments of the light socket surveillance system 202 can be used to determine how many visitors are present within a vicinity of the light socket surveillance system. In doing so, the light socket surveillance system 202 can make various determinations such as whether a party is occurring. For example, in response to the light socket surveillance system 202 determining that the party is occurring, a guardian may thereby receive an alert as to whether a predetermined number of visitors has been met or exceeded within the vicinity.

By determining the number of visitors present within a vicinity, the light socket surveillance system 202 can be used to assess threats such as how many perpetrators are present within the vicinity, as well as how many hostages are present within the vicinity. This information can be particular useful to police or military personnel to effectively assess threat levels.

The light socket surveillance system 202 can be located in any suitable location to thereby detect a number of visitors. In some embodiments the light socket surveillance system 202 can be located inside a home of a homeowner. Accordingly, the particular vicinity that the light socket surveillance 202 can monitor may be a room located inside the home. As well, the light socket surveillance system 202 can be located outside a home of a homeowner, and the vicinity can be an area of an outer premise where the home is located. Generally, it should be appreciated that the light socket surveillance system 202 can be located in any location whereby it would be useful to determine a number of visitors in a location.

The light socket surveillance system 202 can also determine an identity of any of the visitors located within a vicinity of the light socket surveillance system 202. In order to determine the identity of any of the visitors, the light socket surveillance system 202 can be implemented with facial recognition or any technology capable of determining visitor identity.

The light socket surveillance system 202 may also initiate a communication session with a remote computing device. The communication session can comprise any variety of information, such as the number of visitors located within the vicinity, the identity of any of the visitors, whether a party is occurring, etc. The remote computing device can be operated by a homeowner, a resident of the home, a guardian of a resident of the home, a neighbor, and the like.

The light socket surveillance system 202 can also be implemented with an infrared camera that can detect an infrared signature of a visitor. This can be useful if the vicinity is not adequately lit. The light socket surveillance system 202 can determine the presence of unique infrared signatures, which can indicate the number of visitors present within the vicinity of the light socket surveillance system 202.

### COMBINATIONS WITH EMBODIMENTS INCORPORATED BY REFERENCE

The embodiments described herein can be combined with any of the embodiments included in the applications incorporated by reference. In various embodiments, the security systems described herein can include features and methods described in the context of security systems from applications incorporated by reference.

### Interpretation

None of the steps described herein is essential or indispensable. Any of the steps can be adjusted or modified. Other or additional steps can be used. Any portion of any of the steps, processes, structures, and/or devices disclosed or illustrated in one embodiment, flowchart, or example in this specification can be combined or used with or instead of any other portion of any of the steps, processes, structures, and/or devices disclosed or illustrated in a different embodiment, flowchart, or example. The embodiments and examples provided herein are not intended to be discrete and separate from each other.

The section headings and subheadings provided herein are nonlimiting. The section headings and subheadings do not represent or limit the full scope of the embodiments described in the sections to which the headings and subheadings pertain. For example, a section titled “Topic 1” may include embodiments that do not pertain to Topic 1 and embodiments described in other sections may apply to and be combined with embodiments described within the “Topic 1” section.

Some of the devices, systems, embodiments, and processes use computers. Each of the routines, processes, methods, and algorithms described in the preceding sections may be embodied in, and fully or partially automated by, code modules executed by one or more computers, computer processors, or machines configured to execute computer instructions. The code modules may be stored on any type of non-transitory computer-readable storage medium or tangible computer storage device, such as hard drives, solid state memory, flash memory, optical disc, and/or the like. The processes and algorithms may be implemented partially or wholly in application-specific circuitry. The results of the disclosed processes and process steps may be stored, persistently or otherwise, in any type of non-transitory computer storage such as, e.g., volatile or non-volatile storage.

The various features and processes described above may be used independently of one another, or may be combined in various ways. All possible combinations and subcombinations are intended to fall within the scope of this disclosure. In addition, certain method, event, state, or process blocks may be omitted in some implementations. The methods, steps, and processes described herein are also not limited to any particular sequence, and the blocks, steps, or states relating thereto can be performed in other sequences that are appropriate. For example, described tasks or events may be performed in an order other than the order specifically disclosed. Multiple steps may be combined in a single block or state. The example tasks or events may be performed in serial, in parallel, or in some other manner. Tasks or events may be added to or removed from the disclosed example embodiments. The example systems and components described herein may be configured differently than described. For example, elements may be added to, removed from, or rearranged compared to the disclosed example embodiments.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations and so forth. Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require at least one of X, at least one of Y, and at least one of Z to each be present.

The term “and/or” means that “and” applies to some embodiments and “or” applies to some embodiments. Thus, A, B, and/or C can be replaced with A, B, and C written in one sentence and A, B, or C written in another sentence. A, B, and/or C means that some embodiments can include A and B, some embodiments can include A and C, some embodiments can include B and C, some embodiments can only include A, some embodiments can include only B, some embodiments can include only C, and some embodiments can include A, B, and C. The term “and/or” is used to avoid unnecessary redundancy.

While certain example embodiments have been described, these embodiments have been presented by way of example only, and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions, and changes in the form of the methods and systems described herein may be made without departing from the spirit of the inventions disclosed herein.

The following is claimed:

1. A method for using a light socket surveillance system to enable a first party to communicate with a second party, wherein the light socket surveillance system includes an outer housing defining a proximal end, a distal end that is opposite the proximal end, and a sidewall that extends between the proximal end and the distal end, wherein the light socket surveillance system includes a detection system having a camera, a motion detector, a speaker, and a microphone, and wherein the light socket surveillance system includes a screw thread contact located adjacent the proximal end of the outer housing, the method comprising:
detecting, via the microphone, an audible notification from the first party;
in response to detecting the audible notification from the first party, determining a number of visitors present within a vicinity of the light socket surveillance system; and
in response to detecting the audible notification from the first party, initiating a communication session with a software application running on a remote computing device of the second party, wherein the communication session comprises the number of visitors present within the vicinity of the light socket surveillance system.

2. The method of claim 1, wherein the audible notification comprises a voice command instructing the light socket surveillance system to contact the second party, the method further comprising enabling, via the speaker and the microphone, the first party and the second party to audibly communicate with each other.

3. The method of claim 1, wherein the audible notification comprises a distress notification indicating that the first party requires assistance, and wherein the communication session comprises an indication of the distress notification.

4. The method of claim 1, further comprising:
recording a noise with the microphone;
recording an image with the camera; and
initiating a communication session with the software application running on the remote computing device of the second party, wherein the communication session comprises an indication of at least one of the noise and image.

5. The method of claim 4, wherein the sidewall comprises a first portion and a second portion that is rotatable with respect to the first portion, wherein the camera is coupled to the second portion, the method further comprising:
determining whether the first party is located within a field of view of the camera;
in response to detecting the audible notification and in response to determining that the first party is not located within the field of view of the camera, automatically rotating the second portion until the first party is located within the field of view of the camera; and
in response to determining that the first party is located within the field of view of the camera, recording the image with the camera.

6. The method of claim 1, wherein the light socket surveillance system is located inside a home of a homeowner, and wherein the vicinity is a room located inside the home.

7. The method of claim 1, further comprising wherein the light socket surveillance system is located outside a home of a homeowner, and wherein the vicinity is an area of an outer premise where the home is located.

8. The method of claim 4, further comprising detecting an indication suggestive of a presence of a visitor, wherein detecting the indication suggestive of the presence of the visitor comprises detecting an infrared signature of the visitor,
wherein the light socket surveillance system comprises an infrared camera, and
wherein detecting the infrared signature of the visitor comprises detecting the infrared signature of the visitor with the infrared camera.

9. The method of claim 4, further comprising:
detecting an indication suggestive of a visitor's presence;
in response to detecting the indication suggestive of a visitor's presence, recording, by the camera, a media selected from the group consisting of a video, an image, and combinations thereof, of the visitor; and
initiating a communication session with a software application running on a remote computing device, wherein the communication session comprises, the media selected from the group consisting of the video, the image, and combinations thereof, of the visitor.

10. The method of claim 9, further comprising determining an identity of a first visitor.

11. The method of claim 10, further comprising determining an identity of a second visitor.

12. The method of claim 11, wherein the communication session comprises the identity of the first visitor and the identity of the second visitor.

13. The method of claim 12, wherein the software application running on the remote computing device is operated by a party associated with a building in which the light socket surveillance system is coupled.

14. A light socket surveillance system, comprising:
an outer housing defining a proximal end, a distal end that is opposite the proximal end, and a sidewall that extends between the proximal end and the distal end;
a screw thread contact coupled to the proximal end of the outer housing, wherein the screw thread contact is rotatably attached to a light socket; and
a detection system coupled to the outer housing, wherein the detection system comprises a camera configurable to record images, a motion detector configured to detect motion, a speaker configurable to emit noise, a microphone configurable to detect sound, and an infrared camera configured to detect an infrared signature of a visitor.

15. The light socket surveillance system of claim 14, wherein the infrared camera is configured to determine a presence of at least one unique infrared signature, thereby indicating a number of visitors present within a vicinity of the light socket surveillance system.

16. The light socket surveillance system of claim 15, further comprising a communication module configured to enable wireless communication with a remote computing device.

17. The light socket surveillance system of claim 16, wherein the communication module is configured to send at least one communication session to a software application running on the remote computing device.

18. The light socket surveillance system of claim 17, wherein the at least one communication session comprises information selected from the group consisting of images recorded by the camera, sound detected by the microphone, the number of visitors present within the vicinity of the light socket surveillance system, and combinations thereof.

19. The light socket surveillance system of claim 14, further comprising a plurality of LED lights coupled to the distal end of the outer housing, the plurality of LED lights configured to emit light.

20. The light socket surveillance system of claim 19, wherein the plurality of LED lights is configured to at least partially surround the detection system.
